(19) United States
(12) Patent Application Publication
(10) Pub. No.: US 2025/0226992 A1
(43) Pub. Date: Jul. 10, 2025

(54) BLOCKCHAIN TRANSACTION PROCESSING METHOD, RELATED DEVICE, AND MEDIUM

(71) Applicant: Tencent Technology (Shenzhen) Company Limited, Shenzhen (CN)

(72) Inventor: Zimin CHEN, Shenzhen (CN)

(73) Assignee: Tencent Technology (Shenzhen) Company Limited, Shenzhen (CN)

(21) Appl. No.: 19/096,025

(22) Filed: Mar. 31, 2025

Related U.S. Application Data
(63) Continuation of application No. PCT/CN2023/124129, filed on Oct. 12, 2023.

(30) Foreign Application Priority Data
Jan. 31, 2023 (CN) 202310145364.8

(51) Int. Cl. H04L 9/32

(52) U.S. Cl. CPC H04L 9/3247

(57) ABSTRACT

A blockchain transaction processing method, a related device, and a medium. The method includes: receiving a transaction request from a target relay node and a first signature, the first signature being generated by signing the transaction request using a first signature algorithm of the blockchain node, the transaction request including a transaction sub-request received by the target relay node from a terminal, the transaction sub-request having a second signature, and the second signature being generated by using a second signature algorithm in a terminal contract; performing first signature verification on the first signature by using the first signature algorithm; and invoking a relay contract of the target relay node after the first signature verification succeeds, to perform second signature verification on the transaction sub-request by using the second signature algorithm.

### RELATED APPLICATION

This application is a continuation application of PCT Patent Application No. PCT/CN2023/124129, filed on Oct. 12, 2023, which claims priority to Chinese Patent Application No. 202310145364.8, filed with the China National Intellectual Property Administration on Jan. 31, 2023, each of which is incorporated herein by reference in its entirety.

### FIELD OF THE TECHNOLOGY

This application relates to the blockchain field, and in particular, to a blockchain transaction processing technology.

### BACKGROUND OF THE DISCLOSURE

When a terminal generates a transaction that needs to be uploaded to a blockchain, the terminal needs to sign the transaction and send the signed transaction to a blockchain node for signature verification. After the signature verification succeeds, a consensus is reached and the transaction is uploaded to the blockchain. In the related art, the terminal needs to use a signature algorithm provided by a consensus layer for signing, and the blockchain node also needs to use a corresponding signature algorithm for signature verification. However, such a signature algorithm is not resistant to quantum attacks, and is easily cracked by a third party. In addition, such a signature algorithm is not flexible enough in terms of service compatibility, and is not conducive to development of zero-knowledge proof applications.

### SUMMARY

Embodiments of this disclosure provide a blockchain transaction processing method, a related device, and a medium, which can support a terminal in using a personalized signature algorithm on a blockchain network, to improve service compatibility and a capability to resist quantum attacks.

According to an aspect of this application, a blockchain transaction processing method is provided. The blockchain transaction processing method is applied to a blockchain node, and includes: receiving a transaction request from a target relay node and a first signature of the transaction request, the first signature being generated by signing the transaction request using a first signature algorithm of the blockchain node, the transaction request including a transaction sub-request received by the target relay node from a terminal, the transaction sub-request having a second signature, and the second signature being generated by using a second signature algorithm in a terminal contract of the terminal; performing first signature verification on the first signature by using the first signature algorithm; and invoking a relay contract of the target relay node after determining that the first signature verification succeeds, obtaining a transaction sub-request from the transaction request based on the relay contract, invoking the terminal contract of the terminal corresponding to the transaction sub-request, and performing second signature verification on the transaction sub-request by using the second signature algorithm in the terminal contract.

According to an aspect of this application, a blockchain node is provided, including: a first receiving unit, configured to receive a transaction request from a target relay node and a first signature of the transaction request, the first signature being generated by signing the transaction request using a first signature algorithm of the blockchain node, the transaction request including a transaction sub-request received by the target relay node from a terminal, the transaction sub-request having a second signature, and the second signature being generated by using a second signature algorithm in a terminal contract of the terminal; a first signature verification unit, configured to perform first signature verification on the first signature by using the first signature algorithm; and a second signature verification unit, configured to: invoke a relay contract of the target relay node after determining that the first signature verification succeeds, obtain a transaction sub-request from the transaction request based on the relay contract, invoke the terminal contract of the terminal corresponding to the transaction sub-request, and perform second signature verification on the transaction sub-request by using the second signature algorithm in the terminal contract.

According to an aspect of this application, an electronic device is provided, including a memory and a processor, the memory having a computer program stored therein, and the processor, when executing the computer program, implementing the blockchain transaction processing method described above.

According to an aspect of this application, a computer-readable storage medium is provided, the storage medium having a computer program stored therein, the computer program, when executed by a processor, implementing the blockchain transaction processing method described above. In this disclosure, the computer-readable storage medium may include non-transitory computer-readable storage medium.

According to an aspect of this application, a computer program product is provided, including a computer program, the computer program being read and executed by a processor of a computer device, to cause the computer device to perform the blockchain transaction processing method described above.

In the embodiments of this disclosure, a terminal does not directly request a blockchain node to execute a transaction and upload the transaction to a blockchain, but sends a transaction sub-request to a target relay node. The target relay node places the transaction sub-request into a transaction request, generates a first signature, and sends the first signature to the blockchain node. The first signature is generated based on a first signature algorithm common to the blockchain node, so that signature verification can be smoothly performed on the blockchain node. After the signature verification, a relay contract of the target relay node may be invoked. As a smart contract, the relay contract may specify any personalized processing. The relay node specifies in the relay contract that, when the relay contract is executed, a transaction sub-request in a transaction request is taken out, and a terminal contract of a corresponding terminal is invoked for second signature verification. The second signature verification signature is personalized signature verification. The terminal contract of the terminal includes a second signature algorithm personalized to an object, and the transaction sub-request includes a second signature signed by using the personalized second signature algorithm. Therefore, the personalized second signature algorithm in the terminal contract may be used for performing personalized signature verification on the second signature signed by using the second signature algorithm in the transaction sub-request. In this way, in the embodiments of this disclosure, the terminal can use a personalized signature algorithm on the blockchain network, to improve the service compatibility and the capability to resist quantum attacks.

### BRIEF DESCRIPTION OF THE DRAWINGS

The accompanying drawings are used to provide a further understanding of technical solutions of this application, and constitute a part of the specification, are used to explain the technical solutions in this application in combination with the embodiments of this disclosure, and do not constitute a limitation to the technical solutions in this application.

FIG. 1 is a system architecture diagram of a system to which a blockchain transaction processing method is applied according to an embodiment of this application.

FIG. 2A to FIG. 2H are schematic diagrams of a blockchain transaction processing method applied to a virtual resource transfer scenario according to an embodiment of this application.

FIG. 3 is a flowchart of a blockchain transaction processing method according to an embodiment of this application.

FIG. 4 is a flowchart of a process of generating a transaction request in operation 310 in FIG. 3.

FIG. 5A to FIG. 5C are schematic structural diagrams of a transaction sub-request in operation 410 in FIG. 4.

FIG. 6 is an example flowchart of operation 430 in FIG. 4.

FIG. 7 is another system architecture diagram of a system to which a blockchain transaction processing method is applied according to an embodiment of this application.

FIG. 8A and FIG. 8B are two flowcharts of the operation 410 in FIG. 4.

FIG. 9 is a specific flowchart of executing a relay contract of a target relay node in operation 330 in FIG. 3.

FIG. 10 is a schematic structural diagram of a transaction request in operation 910 in FIG. 9.

FIG. 11 is a flowchart of operation 920 in FIG. 9.

FIG. 12 is a schematic structural diagram of a first block in operation 1120 in FIG. 11.

FIG. 13 is a specific flowchart of a process of making a relay contract in the operation 330.

FIG. 14 is a specific flowchart of invoking a terminal contract in operation 330 in FIG. 3.

FIG. 15 is a specific flowchart of a process of invoking a terminal contract corresponding to a terminal identifier in operation 1420 in FIG. 14.

FIG. 16 is a specific flowchart of a process of making the terminal contract in operation 330.

FIG. 17 is a specific flowchart after a process of executing a transaction logic contract is added based on FIG. 3.

FIG. 18 is a specific flowchart of invoking a transaction logic contract corresponding to a transaction type in operation 1720 in FIG. 17.

FIG. 19 is a specific flowchart after a process of notifying a target terminal of an execution result is added based on FIG. 17.

FIG. 20A and FIG. 20B are schematic diagrams of an integrated execution result in operation 1910 in FIG. 19.

FIG. 21 is a more detailed flowchart of a blockchain transaction processing method according to an embodiment of this application.

FIG. 22 is a module diagram of a blockchain node according to an embodiment of this application.

FIG. 23 is a structural diagram of a terminal that implements the blockchain transaction processing method shown in FIG. 3 according to an embodiment of this application.

FIG. 24 is a structural diagram of a server that implements the blockchain transaction processing method shown in FIG. 3 according to an embodiment of this application.

### DESCRIPTION OF EMBODIMENTS

To make the objectives, technical solutions, and advantages of this application clearer, the following describes this application in further detail with reference to the accompanying drawings and the embodiments. The specific embodiments described herein are merely used to explain this application but are not intended to limit this application.

Before embodiments of this disclosure are described in further detail, descriptions are made on terms in the embodiments of this disclosure, and the terms in the embodiments of this disclosure are applicable to the following explanations.

Blockchain: The blockchain is a new application mode of computer technologies such as distributed data storage, peer-to-peer transmission, a consensus mechanism, and an encryption algorithm. The blockchain is essentially a decentralized database, and is a string of data blocks generated through association by using a cryptographic method. Each data block includes information about a batch of transactions, which is configured for verifying validity (anti-counterfeiting) of the information and associating with a previous block.

Signature algorithm: The signature algorithm is an important part in blockchain security, while an address, a public key, a private key, and the like of a blockchain are all related to the signature algorithm. Ownership of a blockchain is implemented through a private key, a blockchain address, and a digital signature. The private key is owned only by an object, and is stored only in an object terminal. Authentication and management of the ownership are both based on the signature algorithm. Therefore, trust of the blockchain is established based on successful verification of the signature algorithm.

Smart contract: The smart contract is a segment of code written on a blockchain. Once a clause, a rule, or a condition in the contract is triggered to be executed on the blockchain at a specific time, the code is automatically executed. In some example implementations, the code may include executable code.

Currently, many applications start to use a blockchain network, because a decentralization characteristic of the blockchain network has the following advantages: strong fault tolerance, not easy to be attacked, and data cannot be tampered with. Therefore, an object trusts an application deployed with the blockchain. Off-chain objects have increasingly more activities on the blockchain, and more and more transactions need to be uploaded to the blockchain. Therefore, there is a need to ensure information security and improve service compatibility in a process of uploading a transaction to a blockchain.

In the related art, a specific implementation of uploading a transaction to a blockchain is as follows: when a terminal generates a transaction that needs to be uploaded to the blockchain, the terminal signs the transaction, and sends the transaction and the signature directly to a blockchain node. The blockchain node performs signature verification on the signature, and after the signature verification succeeds, the consensus is reached, and the transaction is uploaded to the blockchain. Two disadvantages of such an implementation are as follows: First, the terminal needs to use a uniform signature algorithm of a consensus layer during signature. During signature verification, the blockchain node uses only the signature algorithm for signature verification. However, the uniform signature algorithm is not resistant to quantum attacks, is easily cracked by a third party, and cannot ensure the information security. In addition, different services may need to use different signature algorithms. Therefore, the service compatibility is not flexible enough, which is not conducive to development of zero-knowledge proof applications.

In the embodiments of this disclosure, signature verification can be performed by using different signature algorithms, thereby improving security and service compatibility of uploading a transaction to a blockchain.

Descriptions of a System Architecture and Scenarios of a System to which the Embodiments of this Disclosure is Applied

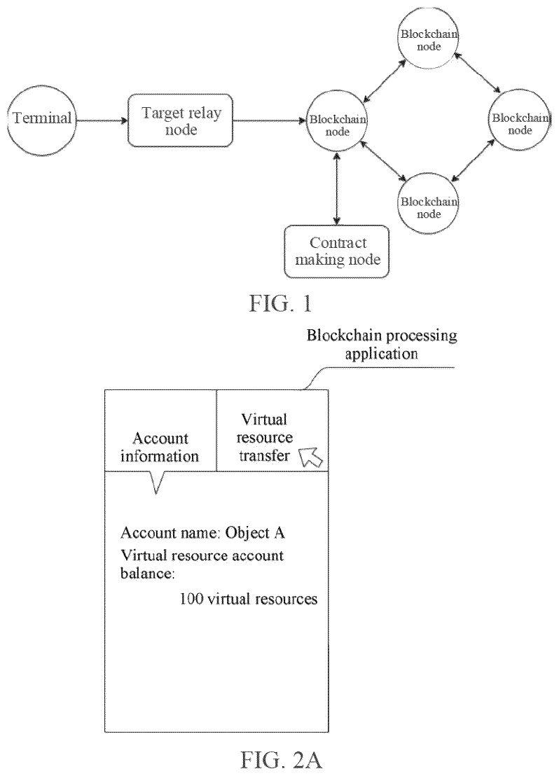

FIG. 1 is a system architecture diagram of a system to which a blockchain transaction processing method is applied according to an embodiment of this application. The system includes a terminal, a target relay node, a blockchain node, and a contract making node.

The terminal is configured to initiate a blockchain transaction processing request. The terminal may be in a plurality of forms such as a desktop computer, a laptop computer, a mobile phone, a personal digital assistant (PDA), an in-vehicle terminal, a dedicated terminal, and a server. The blockchain transaction processing request is a transaction request that needs to be uploaded to a blockchain. For example, requests such as exchange or transfer of virtual resources and virtual resource query. An object may sign a transaction through the terminal. The object may be a user.

The target relay node is configured to: receive transaction sub-requests from a plurality of terminals and signatures (for example, second signatures) of the terminals, package the plurality of transaction sub-requests and the signatures of the terminals that are received to form a transaction request, perform signature (for example, a first signature) on the transaction request on a target relay node side, and send the transaction request and the signature of the target relay node to the blockchain node.

The blockchain node is a core processing unit of the blockchain transaction processing method in the embodiments of this disclosure. The blockchain node performs signature verification (for example, first signature verification) on the transaction request sent by the relay node and the signature of the target relay node, and invokes a relay contract after the signature verification succeeds, to invoke a terminal contract corresponding to each transaction sub-request. Each transaction sub-request may use a different signature algorithm due to a different service. Therefore, a corresponding terminal contract needs to be invoked for signature verification (for example, second signature verification) for each transaction sub-request, to perform transaction processing. A common signature verification process of the blockchain node cannot support this. Therefore, in the embodiments of this disclosure, such a personalized signature verification process is hidden in a process of executing the relay contract after the signature verification for the target relay node succeeds. As a smart contract, the relay contract may specify any personalized processing. This is also the key to the blockchain transaction processing method in the embodiments of this disclosure that different signature algorithms can be used to sign the transaction request to ensure the information security and the service compatibility. Specific implementations are described in the following detailed descriptions. The blockchain node is further configured to: receive contract making rules from different nodes, and send the contract making rules to a contract making node. Blockchain nodes may communicate with each other for data transmission.

The contract making node is a unit configured to generate a contract. The contract making node codes a received contract making rule, and transmits a generated contract to the blockchain node for storage.

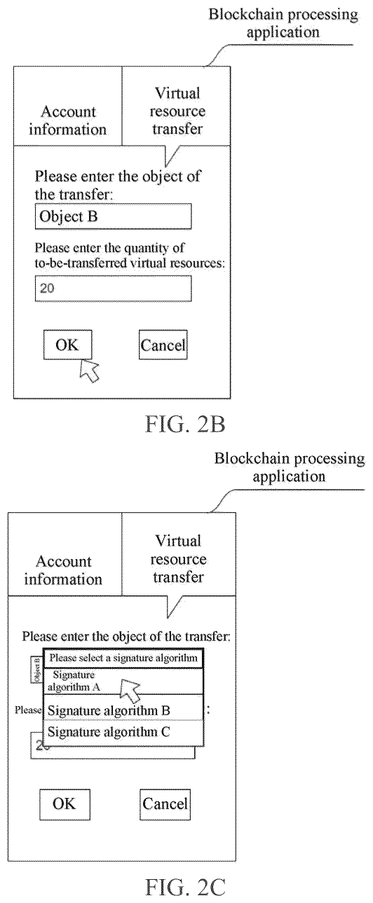

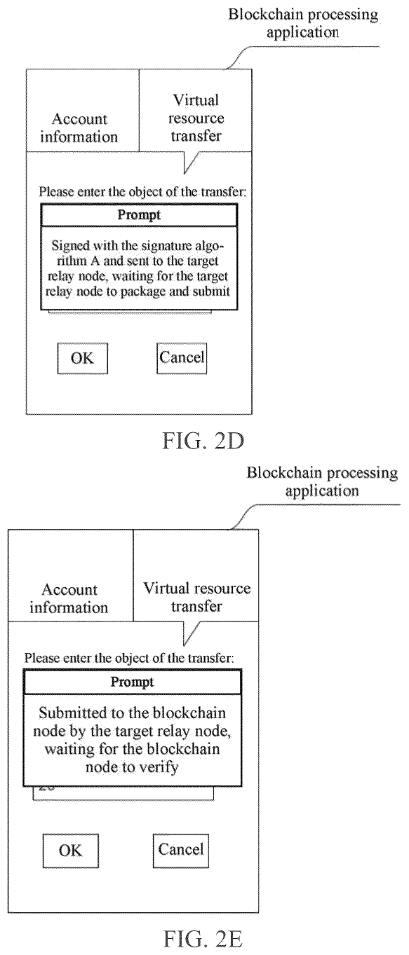

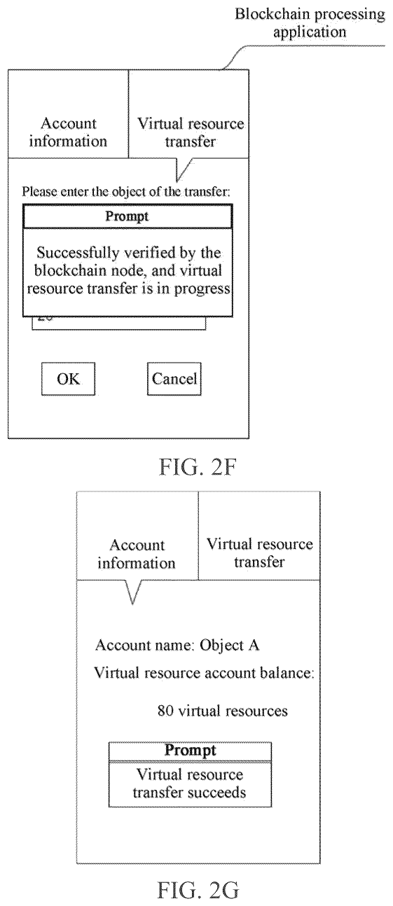

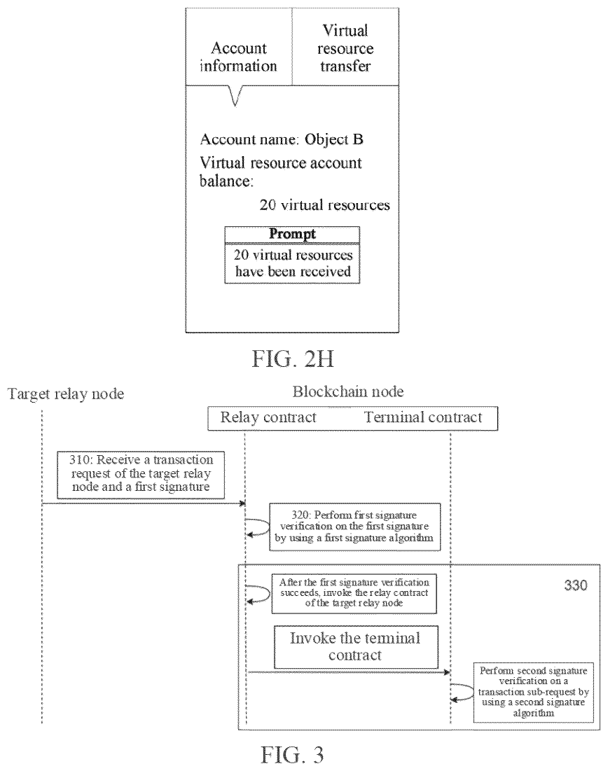

The embodiments of this disclosure may be applied to various scenarios, for example, virtual resource transfer scenarios shown in FIG. 2A to FIG. 2H.

The blockchain may be configured to transfer virtual resources between accounts of different objects (e.g., owners). If an object has a virtual resource account in a blockchain network, the object may perform an operation on the virtual resources in a blockchain processing application. Generally under current technology, when the object performs virtual resource transfer, a transaction request can be sent to the blockchain node to be uploaded to the blockchain only after the terminal signs the transaction request once, and a used signature algorithm is fixed. However, such a manner is easily attacked during transmission, threatening the information security. Therefore, there is a need to use a transaction processing method that is not easily attacked, to ensure the information security.

The transaction processing method in the embodiments of this disclosure can meet this requirement. The object may select different signature algorithms to sign a virtual resource transfer request. However, if the blockchain node uses a new signature algorithm to perform signature verification each time the blockchain node receives a new request, transaction processing efficiency is low. Therefore, in the processing method in the embodiments of this disclosure, the relay node is configured, to package a plurality of transaction sub-requests and perform one-time signature on a packaged transaction request. In this way, the blockchain node first performs signature verification on the transaction request once, and then processes each transaction sub-request one by one after the signature verification succeeds. In this way, a problem of reduced processing efficiency is avoided, and different signature algorithms used by different transaction sub-requests are retained, thereby effectively improving security of transaction processing.

For example, an object A wants to transfer 20 virtual resources to an object B.

As shown in FIG. 2A, account information the object A, including an account name and a virtual resource account balance, is displayed in a blockchain processing application of the object A. Currently, the virtual resource account balance of the object A is 100 virtual resources. The object A may select a “Virtual resource transfer” function to generate a virtual resource transfer transaction request to perform virtual resource transfer to an account of the object B.

After the object A selects the “Virtual resource transfer” function, a changed interface is shown in FIG. 2B, and the object A needs to enter the object B and a quantity of virtual resources to be transferred. As shown in the figure, the object A is to transfer 20 virtual resources to the object B.

After the object A confirms virtual resource transfer information, the blockchain processing application generates a transfer request. In this case, as shown in FIG. 2C, the object A needs to select a signature algorithm to sign the transfer request. The blockchain processing application pops up a window of “Please select a signature algorithm”. The signature algorithm may be selected by the object through customization, and the object A selects a signature algorithm A.

As shown in FIG. 2D, after the object A selects the signature algorithm, the blockchain processing application generates a signature for the transfer request based on the corresponding signature algorithm, and sends the transfer request and the signature to the target relay node. A pop-up prompt “Signed with the signature algorithm A and sent to the target relay node, waiting for the target relay node to package and submit” appears in the application.

As shown in FIG. 2E, the target relay node packages the transfer request (namely, the transaction sub-request sent by the terminal of the object A) and the signature received from the terminal of the object A and a transaction sub-request and signature received from another terminal, and transmits packaged transaction sub-requests and signatures to the blockchain node. A pop-up prompt “Submitted to the blockchain node by the target relay node, waiting for the blockchain node to verify” appears in the blockchain processing application.

As shown in FIG. 2F, the blockchain node performs signature verification on the transfer request, and performs virtual resource transfer after the verification succeeds. A pop-up prompt “Successfully verified by the blockchain node, and virtual resource transfer is in progress” appears in the blockchain processing application.

As shown in FIG. 2G, the blockchain network completes the virtual resource transfer, and separately feeds back a processing result to the object A. The object A is a transfer request proposer, and a pop-up prompt “Virtual resource transfer succeeds” appears in the blockchain processing application of the object A. In this case, the virtual resource account balance of the object A is 80 virtual resources.

As shown in FIG. 2H, the blockchain network completes the virtual resource transfer, and separately feeds back a processing result to the object B. The object B is a virtual resource receiver, and a pop-up prompt “20 virtual resources have been received” appears in the blockchain processing application of the object B. A virtual resource account balance of the object B before receiving is 0, and is changed to 20 virtual resources currently.

### General Descriptions of the Embodiments of this Disclosure

According to an embodiment of this application, a blockchain transaction processing method is provided. Blockchain transaction processing specifically means processing an off-chain transaction request and uploading a processing result to the blockchain. The blockchain transaction processing method is performed by a blockchain node in a blockchain network.

As shown in FIG. 3, according to an embodiment of this application, the blockchain transaction processing method includes: operation 310: receiving a transaction request from a target relay node and a first signature of the transaction request; operation 320: performing first signature verification on the first signature by using a first signature algorithm; and operation 330: invoking a relay contract of the target relay node after determining that the first signature verification succeeds, obtaining a transaction sub-request from the transaction request based on the relay contract, invoking a terminal contract of a terminal corresponding to the transaction sub-request, and performing second signature verification on the transaction sub-request by using a second signature algorithm in the terminal contract. In some example implementations, a contract, such as the relay contract or the terminal contract, when invoked or executed, may perform actions that are defined or required in the contract. For example, in operation 330, when the relay contract is invoked, the action would be “obtaining a transaction sub-request from the transaction request based on the relay contract”; when the terminal contract is invoked (or executed), the action would be “performing second signature verification on the transaction sub-request by using a second signature algorithm in the terminal contract”. Therefore, essentially the actions are based on the contract. The same principle applies to all other contracts in this disclosure.

The following briefly describes operations 310 to 330.

The first signature in operation 310 is generated by signing the transaction request using the first signature algorithm of the blockchain node. The first signature algorithm is a signature algorithm specified by the blockchain network to be used for sending the transaction request, and is usually consistent with a signature algorithm used during consensus before uploading blockchain nodes to the blockchain, or causes difficulty in consensus otherwise. The transaction request is a set storing a plurality of transaction sub-requests, and includes transaction sub-requests received by the target relay node from different terminals. The transaction sub-request is a transaction sub-request generated by a terminal and includes a second signature. The second signature is generated by using a second signature algorithm in a terminal contract of the terminal. The second signature algorithm may be set by an object through customization to meet different service needs. The terminal contract is a smart contract established between the terminal and the blockchain network, which can specify some personalized processing based on object requirements, for example, a personalized signature algorithm. Different second signature algorithms may be used for different transaction sub-requests in a transaction request, to improve security and service compatibility during transaction processing.

The signature may be digesting a to-be-signed subject by using a digest algorithm (such as a Hash algorithm), and then encrypting a digest by using a private key (or a public key) of a signer. A difference between signature algorithms may be reflected in using different abstract algorithms, and the like. When the first signature is generated, the target relay node digests the transaction request by using a general digest algorithm (not personalized), and encrypts a digest by using a public key of the blockchain node. When the second signature is generated, the terminal digests the transaction sub-request generated by the terminal by using a digest algorithm personalized to the terminal, and encrypts a digest by using a private key of the terminal.

In operation 320, signature verification is performed on the first signature generated in operation 310 on the blockchain node by using the first signature algorithm.

The signature verification may be decrypting a signature by using a public key (or a private key) of a signer, digesting a to-be-signed subject by using a digest algorithm (for example, a Hash algorithm), and comparing a decryption result with a digest. If the decryption result and the digest are consistent, the signature verification succeeds. During first signature verification performed on the first signature, the blockchain node decrypts the first signature by using a private key of the blockchain node, digests the transaction request by using a general digest algorithm (not personalized), and compares a decryption result with a digest. If the decryption result and the digest are consistent, signature verification succeeds.

In operation 330, the relay contract of the target relay node is invoked after it is determined that the first signature verification succeeds. The relay contract of the target relay node invokes a corresponding terminal contract based on the transaction sub-request in the transaction request. The terminal contract performs signature verification on the transaction sub-request by using the second signature algorithm customized by the object, to execute the transaction sub-request.

The relay contract is a smart contract established between the relay node and the blockchain network, and can specify some personalized processing of the relay node based on requirements of the relay node. For example, in the embodiments of this disclosure, the relay contract specifies that, for each transaction sub-request included in the transaction request, terminal contracts corresponding to transaction sub-requests are executed one by one, and the terminal contract specifies that signature verification is performed on the transaction sub-requests by using a second signature algorithm personalized to each terminal. In this way, signature verification by using the personalized signature algorithm required by the terminal can still be implemented without violating a general signature verification procedure.

During signature verification performed on the second signature, a manner of the second signature verification may be that the terminal contract decrypts the second signature by using a public key of the corresponding terminal, digests the transaction sub-request by using the digest algorithm personalized to the terminal, and compares a decryption result with a digest. If the decryption result and the digest are consistent, the signature verification succeeds.

The foregoing briefly describes operations 310 to 330, and the following describes specific implementation of each of operations 310 to 330 in detail.

### Detailed Descriptions of Operation 310

In operation 310, the blockchain node receives the transaction request and the first signature from the target relay node.

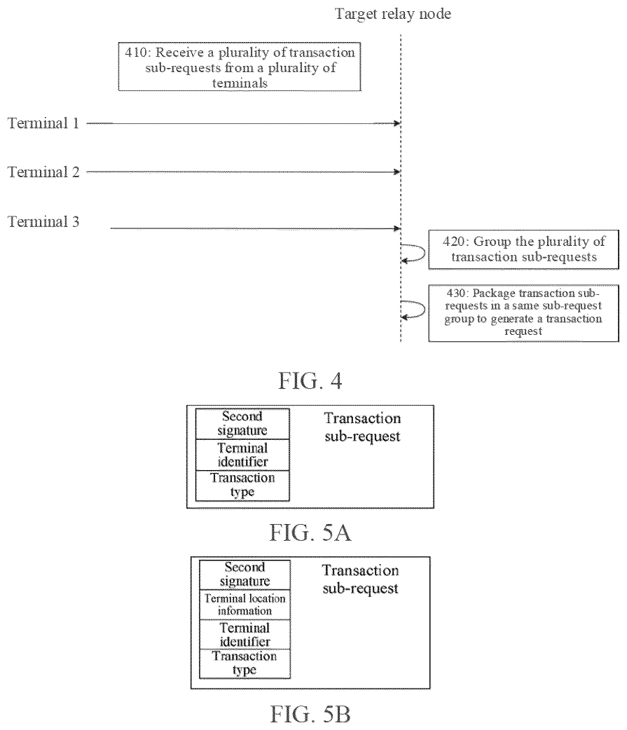

The transaction request includes a plurality of transaction sub-requests. As shown in FIG. 4, in an embodiment, a process of generating a transaction request includes: operation 410: receiving a plurality of transaction sub-requests from a plurality of terminals; operation 420: grouping the plurality of transaction sub-requests; and operation 430: packaging transaction sub-requests in a same sub-request group to generate the transaction request.

Operations 410 to 430 are performed by the target relay node. The following describes operations 410 to 430 in detail.

In operation 410, the target relay node may receive the plurality of transaction sub-requests in a plurality of manners.

In an embodiment, a manner in which the target relay node receives the plurality of transaction sub-requests is directly receiving the plurality of transaction sub-requests from the plurality of terminals. That is, the target relay node does not receive the plurality of transaction sub-requests through another intermediate node (or relay node). In this case, there are two cases. In one case, the target relay node is the only relay node. Any terminal that generates a transaction sub-request can only send the transaction sub-request to the target relay node. In the other case, there are a plurality of relay nodes, but the terminal forms a binding relationship with a relay node. A relay node corresponding to a specific terminal is unique. A relay node bound to a specific terminal is referred to as the target relay node. In this case, the terminal generates a transaction sub-request, and can only send the transaction sub-request to the target relay node. If the target relay node has no remaining storage space or no remaining processing capability, the transaction sub-request sent by the terminal enters a queuing sequence until the target relay node has enough storage space or processing capability to process the transaction sub-request.

In another embodiment, the target relay node receives the transaction sub-request through a distribution node. As shown in a system architecture diagram in FIG. 7, there are a plurality of relay nodes. The relay node is a node that receives the transaction sub-requests and packages the transaction sub-requests into the transaction request, to send the transaction request to the blockchain node. A distribution node exists between the terminal and the plurality of relay nodes, and is configured to receive the transaction sub-request of the terminal and send the transaction sub-request to the relay node. Each of the plurality of relay nodes may receive the transaction sub-request assigned from the distribution node, and send the packaged transaction request to the blockchain node. In this embodiment, a specific process of sending the transaction request by the distribution node includes: receiving the transaction sub-request from the terminal; selecting one of the plurality of relay nodes as the target relay node; and sending the transaction sub-request to the target relay node.

An advantage of the embodiment in which the distribution node is used is: alleviating a problem in which the transaction processing efficiency is reduced due to uneven work allocation of the relay nodes and that may occur due to use of the direct receiving manner. For example, a remaining storage space of a relay node 1 is 3, a remaining storage space of a relay node 2 is 1, and a remaining storage space of a relay node 3 is 0. A terminal that interworks with the relay node 3 is still transmitting a transaction sub-request to the relay node 3. In this case, the transaction sub-request received by the relay node 3 needs to enter a queuing sequence to wait for current processing to be completed. The relay node 1 and the relay node 2 have an excess space, but do not receive new transaction sub-requests, resulting in low transaction processing efficiency of the relay nodes. Configuration of the distribution node can alleviate this problem. After receiving the transaction sub-request, the distribution node selects a proper relay node as the target relay node to ensure that all relay nodes can work efficiently.

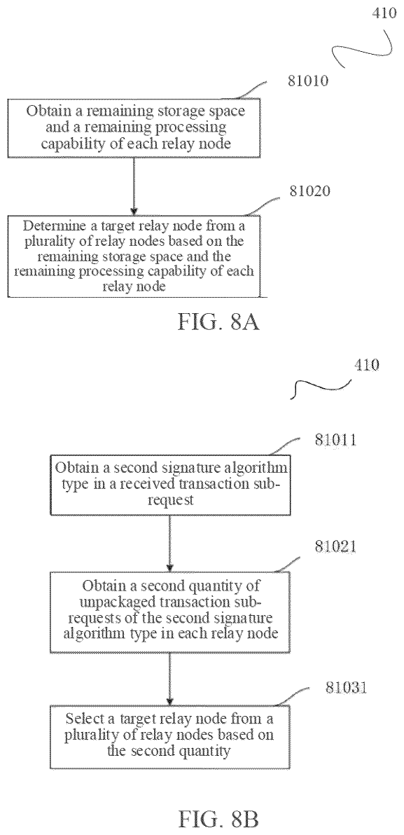

In an embodiment, as shown in FIG. 8A, that one of the plurality of relay nodes is selected as the target relay node includes: operation 81010: obtaining a remaining storage space and a remaining processing capability of each relay node; and operation 81020: determining the target relay node from the plurality of relay nodes based on the remaining storage space and the remaining processing capability of each relay node.

Operations 81010 and 81020 are performed by the distribution node. The following describes operations 81010 and 81020 in detail.

The transaction sub-request received by the distribution node is directly sent by the terminal. By evaluating a current working capability of each relay node, the distribution node determines which relay node is selected for the transaction sub-request to maximize working efficiency. In this embodiment, evaluation indicators for selection are the remaining storage space and the remaining processing capability of the relay node.

The remaining storage space of the relay node is a value obtained by subtracting a space occupied by existing transaction sub-requests in the relay node from a total storage space of the relay node. The remaining processing capability is a value obtained by subtracting a quantity of tasks being processed from an upper limit of a quantity of simultaneously processing tasks of the relay node. For example, a total storage space of a relay node is 10 MB, a space occupied by a transaction sub-request in the relay node is 4 MB, an upper limit of a quantity of simultaneously processing tasks is 1000, a quantity of tasks being processed is 800, a remaining storage space of the relay node is 6 MB (10-4), and a remaining processing capability is 200 tasks (1000-800).

A reason for considering the remaining storage space is that the remaining storage space determines whether the relay node can accommodate the transaction sub-request. A reason for considering the remaining processing capability is that the remaining processing capability determines a processing speed of the relay node. When a value of the remaining processing capability is high, the processing speed is high. The remaining storage space and the remaining processing capability jointly determine whether a relay node can become the target relay node. Considered factors are comprehensive, so that accuracy of selecting the target relay node is improved.

When the target relay node is determined from the plurality of relay nodes based on the remaining storage space and the remaining processing capability of each relay node, a total score of a relay node may be calculated based on the remaining storage space and the remaining processing capability, and a relay node with a highest total score is selected as the target relay node. In an embodiment, operation 81020 includes: determining a first score based on the remaining storage space of the relay node; determining a second score based on the remaining processing capability of the relay node; determining a total score of each relay node based on the first score and the second score; and determining the target relay node from the plurality of relay nodes based on the total score of each relay node.

Based on the remaining storage space of the relay node, the first score may be determined in a manner of searching a comparison table between remaining storage spaces and first scores, by using a formula method, or the like.

The comparison table between remaining storage spaces and first scores lists a correspondence between remaining storage space ranges and first scores. A remaining storage space range to which the remaining storage space belongs is first determined based on the remaining storage space of the relay node, and then the comparison table between remaining storage spaces and first scores is searched accordingly, to obtain the first score. The following is an example of a comparison table between remaining storage spaces and first scores:

TABLE 1

| Remaining storage space range | First score |
|---|---|
| 100 MB or higher | 100 |
| 50 MB to 100 MB | 90 |
| 20 MB to 50 MB | 80 |
| 10 MB to 20 MB | 70 |
| 5 MB to 10 MB | 60 |
| . . . | . . . |

In the foregoing example, the remaining storage space of the relay node is 6 MB, and a corresponding first score is obtained by searching Table 1 as 60.

The foregoing manner of searching the comparison table between remaining storage spaces and first scores has advantages of simplicity, ease of implementation, and low processing overheads.

When the formula method is used, in an embodiment, the first score may be set to be positively proportional to the remaining storage space. For example,

S1=K1·P Formula 1

S1 represents the first score, P represents the remaining storage space, and K1 is a preset constant, and may be set based on actual needs. For example, K1=5/MB, and after P=6 MB is substituted into the formula, the first score is S1=30.

The foregoing manner of determining the first score through a formula has an advantage of high precision, and the formula can be adjusted as required and has high flexibility.

Based on the remaining processing capability of the relay node, the second score may be determined in a manner of searching a comparison table between remaining processing capabilities and second scores, by using a formula method, or the like.

The following is an example of a comparison table between remaining processing capabilities and second scores:

TABLE 2

| Remaining processing capability range | Second score |
|---|---|
| 500 tasks or more | 100 |
| 300 to 499 tasks | 90 |
| 150 to 299 tasks | 80 |
| 70 to 149 tasks | 70 |
| 30 to 69 tasks | 60 |
| . . . | . . . |

In the foregoing example, the remaining processing capability of the relay node is 200 tasks, and a corresponding second score is obtained by searching Table 2 as 80.

Advantages of the embodiment of searching the comparison table between remaining processing capabilities and second scores are similar to the advantages of the embodiment of searching the comparison table between remaining storage spaces and first scores. Therefore, details are not described herein again.

When the formula method is used, in an embodiment, the second score may be set to be positively proportional to the remaining processing capability. For example,

S2=K2·Q Formula 2

S2 represents the second score, Q represents the remaining storage capability, and K1 is a preset constant, which may be set based on actual needs. For example, K2=0.4, and after Q=200 is substituted into the formula, the second score is S2=80.

Advantages of the manner of determining the second score through a formula are similar to the advantages of the foregoing manner of determining the first score through the formula. Therefore, details are not described herein again.

Based on the first score and the second score, the total score of each relay node may be determined by calculating an average or a weighted average of the first score and the second score.

When the average of the first score and the second score is calculated as the total score, for example, a first score of the relay node 1 is 60, and a second score is 40, so that a total score of the relay node 1 is (60+40)/2=50; a first score of the relay node 2 is 50, and a second score is 30, a total score of the relay node 2 is (50+30)/2=40; and a first score of the relay node 3 is 40, and a second score is 70, a total score of the relay node 3 is (40+70)/2=55. An advantage of calculating the total score of the relay node by using the average is that impact of the remaining storage space and the remaining processing capability on selecting the target relay node can be equally reflected.

When the weighted average of the first score and the second score is calculated as the total score, for example, weights of the remaining storage space and the remaining processing capability are respectively set to 0.6 and 0.4, the first score of the relay node 1 is 60, and the second score is 40, so that the total score of the relay node 1 is 60×0.6+40×0.4=52; the first score of the relay node 2 is 50, and the second score is 30, the total score of the relay node 2 is 50×0.6+30×0.4=42; and the first score of the relay node 3 is 40, and the second score is 70, the total score of the relay node 3 is 40×0.6+70×0.4=52. An advantage of calculating the total score by using the weighted average is that different weights can be set for the remaining storage space and the remaining processing capability, thereby improving flexibility of selecting the target relay node.

During determining of the target relay node from the plurality of relay nodes based on the total score of each relay node, in an embodiment, the relay node with a highest total score may be selected as the target relay node. An advantage of this embodiment is that precision of selecting the target relay node is improved.

During determining of the target relay node from the plurality of relay nodes based on the total score of each relay node, in another embodiment, any relay node with a total score greater than a predetermined score threshold may be selected as the target relay node. An advantage of this embodiment is that when the total score is greater than the predetermined score threshold, the relay node meets a requirement of becoming the target relay node, and any relay node may be selected, to avoid re-congestion of the relay node due to always allocating a same relay node to incoming transaction sub-requests as the target relay node in a period of time.

Advantages of the embodiment in which the distribution node selects the target relay node by using the remaining storage space and the remaining processing capability are as follows: A capability of each relay node is effectively evaluated, and the transaction sub-request is transmitted to a proper relay node. In this way, a problem of uneven work allocation of some relay nodes can be avoided, and a waste of resources can be avoided, thereby improving transaction processing efficiency of the relay node.

In operation 420, the received transaction sub-requests need to be grouped. The grouping may be grouping different transaction sub-requests into a sub-request group for subsequent packaging. A reason for the grouping is: the transaction sub-requests in the target relay node need to be packaged. If there are a large quantity of transaction sub-requests, the transaction sub-requests are grouped into different sub-request groups and then packaged, helping improve packaging efficiency and the transaction processing efficiency.

In an embodiment, the received transaction sub-requests are grouped based on a time sequence of entering the target relay node. There is only one sub-request group in which grouping is not completed in the target relay node. After entering the target relay node, the transaction sub-requests are queued in the sub-request group in which grouping is not completed in a time sequence of entering. Once the sub-request group reaches a packaging condition, for example, reaches a predetermined length or reaches a specific time, the group no longer receives a new transaction sub-request, and becomes a sub-request group in which grouping is completed. A sub-request group in which grouping is not completed is further allocated to the target relay node, to accommodate transaction sub-requests entering in the time sequence. An advantage of this embodiment is that a group in which grouping is completed can be formed in minimum time, thereby improving grouping and packaging efficiency.

In another embodiment, a manner of grouping the received transaction sub-requests is grouping based on commonality between the transaction sub-requests. Some transaction sub-requests may have some commonalities, and the commonalities may make it more convenient for the blockchain node to process the transaction sub-requests, which helps improve the processing efficiency in the embodiments of this disclosure. The grouping based on the commonality between the transaction sub-requests specifically includes: obtaining features of the transaction sub-requests; and grouping transaction sub-requests having a same feature into a sub-request group.

In an embodiment, a feature of the transaction sub-request is a terminal identifier. A terminal may send one or more transaction sub-requests. An advantage of grouping transaction sub-requests of a same terminal into a sub-request group for packaging is that the transaction sub-requests from the same terminal may be transaction sub-requests of a same type, and the transaction sub-requests may all be signed by using a same second signature algorithm. The same second signature algorithm may be used during signature verification, which facilitates subsequent signature verification and processing by the blockchain node in the embodiments of this disclosure, and improves the processing efficiency. For example, the object A has a plurality of to-be-processed virtual resource transfer services that are planned by the object A to be collectively processed sequentially, and a plurality of transaction sub-requests are sequentially sent from the terminal of the object A. The target relay node successively receives the transaction sub-requests, and identifies that the transaction sub-requests are from the same terminal, to group all the transaction sub-requests into a sub-request group, so that the blockchain node improves the transaction processing efficiency.

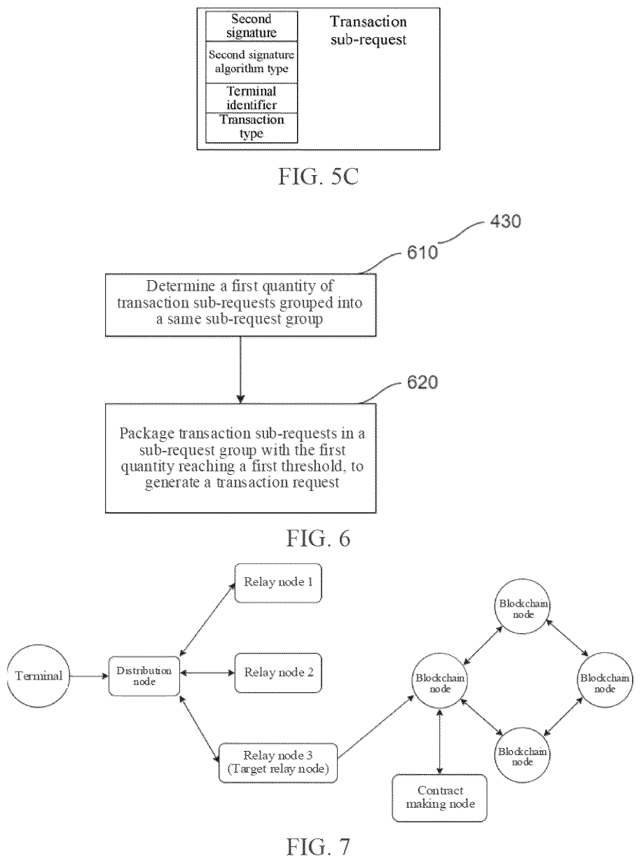

In this embodiment, a structure of the transaction sub-request is shown in FIG. 5A, including: a transaction sub-request body, the second signature, the terminal identifier, and a transaction type. The terminal identifier is configured for identifying the terminal, and the terminal identifier of each terminal is unique. Transaction sub-requests of a same terminal identifier may be grouped into a sub-request group based on the terminal identifier. The transaction type represents a type of the transaction sub-request.

In another embodiment, a feature of the transaction sub-request is a terminal group, and the terminal group may be a group in which the terminal is in. The same terminal group means that, the terminals are in a same group because the terminals have a same characteristic or are associated with each other. The terminal group includes: a group to which an object of a terminal belongs when registering in a blockchain application, a group grouped based on a geographical region, a group to which the object of the terminal in a third-party application belongs, and the like.

The group to which the object of the terminal belongs when registering in the blockchain application may be a group in registration information filled in by the object of the terminal during registering the blockchain application. For example, when the object A first registers a blockchain application, a workplace of the object A filled in is “XX company”. In this case, “XX company” is a group to which the object of the terminal belongs when registering the blockchain application. An advantage of this embodiment is that the object A fills in that the object belongs to the group during registration, and it is possible that people in the group generate similar transactions in daily life and work, and use similar signature algorithms. That transaction sub-requests of a group to which an object of a terminal belongs are grouped into a group may help improve signature verification and processing efficiency of the blockchain node.

The group grouped based on the geographical region is a group related to a geographical region in which the terminal is currently located. The geographical region may be an administrative geographical region, such as China and America, or may be a geographical region on the map divided based on entities, such as an XX company region or an XX school region.

For the administrative geographical region, at the same time, objects in a same administrative region may send same transaction sub-requests, and objects in other administrative regions may not send such transaction sub-requests. For example, from January to February of each year, most transaction sub-requests from terminals in China are virtual resource transfer, because in this period, it is during a Chinese holiday. The signature algorithms required by the transaction sub-requests may be similar, and that the transaction sub-requests are grouped into a group may help improve the signature verification and processing efficiency of the blockchain node.

For geographical regions on the map that are divided based on entities, in the embodiments of this disclosure, geographical regions belonging to a same type may be grouped into a group. For example, all transaction sub-requests from terminals in a movie theater are grouped into a group. Because transaction sub-requests generated by objects in a same type of geographical regions may be similar, the transaction sub-requests are grouped into a group by using similar signature algorithms may help improve the signature verification and processing efficiency of the blockchain node.

In this embodiment, a structure of the transaction sub-request is shown in FIG. 5B, including: the transaction sub-request body, the second signature, terminal location information, the terminal identifier, and the transaction type. A difference from FIG. 5A lies in that the structure of the transaction sub-request in this embodiment records terminal location information. The target relay node determines, by using the terminal location information, a geographical region in which the terminal is currently located.

The group to which the object of the terminal in the third-party application belongs may be a group to which the object belongs in the third-party application. For example, the object further uses a third-party application in addition to the blockchain application. In the third-party application, the object belongs to a group. Objects belonging to the group may often perform a same transaction. Grouping transaction sub-requests of the objects in the same group into a group may improve the transaction processing efficiency of the blockchain node.

In another embodiment, a manner of grouping the received plurality of transaction sub-requests may be grouping the plurality of transaction sub-requests based on a second signature algorithm type. In the embodiments of this disclosure, the second signature algorithm may be selected by the object through customization, and signature and signature verification processes of the second signature algorithms of a same type are similar. Transaction sub-requests on which a same type of second signature algorithms are used are grouped into a group for packaging. The blockchain node may perform uniform signature verification on the transaction sub-requests by using the same type of second signature algorithms, to reduce the need to invoke different types of second signature algorithms for signature verification, so that signature verification efficiency is improved. For example, the blockchain node receives a transaction request, where all transaction sub-requests are signed by using a signature algorithm B, and the blockchain node may perform signature verification by all using the signature algorithm B when processing the transaction sub-requests, alleviating a problem in which the processing efficiency of the blockchain node is reduced because the signature algorithm needs to be changed a plurality of times. In this embodiment, as shown in FIG. 5C, a structure of the transaction sub-request received by the target relay node includes: the transaction sub-request body, the second signature, the second signature algorithm type, the terminal identifier, and the transaction type. The second signature algorithm type is a basis of the transaction sub-requests being grouped in this embodiment.

As described above, in an embodiment of operation 410, the target relay node receives the transaction sub-request through the distribution node, and a principle that the distribution node selects the target relay node for the transaction sub-request is based on the remaining storage space and the remaining processing capability of each relay node. In a case that the target relay node groups the plurality of transaction sub-requests based on the second signature algorithm type, in an embodiment, the distribution node may alternatively select the target relay node based on the second signature algorithm type. As shown in FIG. 8B, that one of the plurality of relay nodes is selected as the target relay node includes: operation 82011: obtaining the second signature algorithm type in the received transaction sub-request; operation 82021: obtaining a second quantity of unpackaged transaction sub-requests of the second signature algorithm type in each relay node; and operation 82031: selecting the target relay node from the plurality of relay nodes based on the second quantity.

The following describes operations 82011 to 82031 in detail.

As described above, in FIG. 5C, the structure of the transaction sub-request includes: the transaction sub-request body, the second signature, the second signature algorithm type, the terminal identifier, and the transaction type, where the second signature algorithm type is mainly configured for helping the target relay node group the transaction sub-requests. An advantage of that the second quantity of unpackaged transaction sub-requests of the second signature algorithm type in each relay node is counted, and the target relay node is selected from the plurality of relay nodes based on the second quantity is as follows: When there are a plurality of relay nodes, the transaction sub-requests of the same second signature algorithm type may be allocated to a plurality of relay nodes, and each relay node groups the transaction sub-requests based on the second signature algorithm type. As a result, there may be only a small quantity of transaction sub-requests in a group of a same second signature algorithm type in each relay node, and none of the transaction sub-requests meets a packaging standard and can be packaged and sent. In this embodiment, the second quantity of the unpackaged transaction sub-requests of the second signature algorithm type in each relay node is counted, and the newly received transaction sub-request of the second signature algorithm type is allocated to a relay node with a largest accumulated second quantity. Therefore, the transaction sub-requests of the second signature algorithm type in the relay node easily meets a packaging requirement, so that the transaction sub-request is quickly packaged and sent, and processing efficiency of the transaction sub-request is improved.

For example, there are two relay nodes, a quantity of transaction sub-requests on which the second signature algorithm A is used is 2, and a quantity of transaction sub-requests on which the second signature algorithm B is used is 4. In each relay node, a quantity of transaction sub-requests on which the second signature algorithm A is used is 1, and a quantity of transaction sub-requests on which the second signature algorithm B is used is 2. If the second signature algorithm type is used in each relay node for grouping, the transaction sub-requests in the two relay nodes are grouped into two sub-request groups, whose quantities of transaction sub-requests are 1 and 2 respectively. The relay node needs to perform packaging twice. In addition, that the quantities are 1 and 2 fail to meet the packing requirement. If the distribution node directly selects the target relay node based on the accumulated second quantity of transaction sub-requests of the same type of the second signature algorithm, when the first relay node has accumulated a transaction sub-request of the first signature algorithm A, and the second relay node has accumulated a transaction sub-request of the first signature algorithm B, subsequent transaction sub-requests of the first signature algorithm A are all sent to the first relay node, and subsequent transaction sub-requests of the first signature algorithm B are all sent to the second relay node. Each relay node needs to perform packaging only once, and the packaging requirement is easily reached, thereby effectively improving the packaging efficiency and efficiency of transmission to the blockchain node.

The second signature algorithm type in operations 82011 and 82021 is obtained through a field of the second signature algorithm type in the transaction sub-request shown in FIG. 5C. In an embodiment, operation 82021 further includes: obtaining unpackaged transaction sub-requests in each relay node; and counting a quantity of transaction sub-requests of the second signature algorithm in the unpackaged transaction sub-requests.

The unpackaged transaction sub-request may be a transaction sub-request that has entered a sub-request group, or may be a transaction sub-request that has just been received and has not entered any sub-request group. The packaged transaction request cannot be changed, and therefore the transaction sub-request in the packaged transaction request does not affect a sub-request group of unpackaged transaction sub-requests. Therefore, the packaged transaction sub-request is not considered in this embodiment. After the transaction sub-request is obtained, the second signature algorithm type used on the transaction sub-request may be obtained through a field of the second signature algorithm type in the structure of the transaction sub-request.

To find a suitable target relay node for the transaction sub-request, a quantity of transaction sub-requests of the second signature algorithm in each relay node needs to be counted. For example, a correspondence between unpackaged transaction sub-requests in the relay node A and second signature algorithm types of the unpackaged transaction sub-requests is: {transaction sub-request a: second signature algorithm type 3; transaction sub-request b: second signature algorithm type 1; transaction sub-request c: second signature algorithm type 2; transaction sub-request d: second signature algorithm type 1; transaction sub-request e: second signature algorithm type 3}. For a transaction sub-request, if a second signature algorithm type of the transaction sub-request is 3, the transaction sub-requests are sequentially traversed, and finally, a quantity of transaction sub-requests with the second signature algorithm type 3 in the relay node A is 2.

Operation 82031 is selecting the target relay node based on the second quantity.

In an embodiment, a relay node with a largest second quantity is selected as the target relay node. An advantage of this embodiment is that the transaction sub-requests of the second signature algorithm type in the target relay node reach the packaging standard as soon as possible, and are packaged as soon as possible, thereby effectively improving response efficiency of the transaction sub-request.

In conclusion, advantages of the embodiments of operations 82011 to 82031 are as follows: The packaging and transmission efficiency of the target relay node can be improved, thereby improving response efficiency of the target transaction sub-request.

In operation 430, the target relay node packages the transaction sub-requests in sub-request groups, and a condition needs to be set for the packaging to ensure that the packaging can be performed in order.

In an embodiment, the target relay node packages transaction sub-requests in a group in every predetermined period. For example, transaction sub-requests in a sub-request group are packaged every 1 minute. Within the predetermined period, each sub-request group may always receive a new transaction sub-request. For example, in the target relay node, the transaction sub-requests are grouped into six groups based on the second signature algorithm type. At the end of 11:54 on Dec. 31, 2022, quantities of transaction sub-requests in the six sub-request groups are respectively: 6, 0, 2, 0, 1, and 0. In this case, six transaction sub-requests in the first sub-request group are packaged into a packet, two transaction sub-requests in the third sub-request group are packaged into a packet, and one transaction sub-request in the fifth sub-request group is packaged into a packet. An advantage of this embodiment is that implementation is simple, and processing overheads are small.

In another embodiment, as shown in FIG. 6, that the target relay node packages transaction sub-request in a group includes: operation 610: determining a first quantity of transaction sub-requests grouped into a same sub-request group; and operation 620: packaging transaction sub-requests in a sub-request group with the first quantity reaching a first threshold, to generate the transaction request.

The first threshold is a value configured or predefined for determining whether the sub-request group reaches the packaging requirement, and represents a quantity of transaction sub-requests in the sub-request group. A setting manner of the first threshold is determining a quantity of transaction sub-requests in the sub-request group when packaging efficiency of the target relay node is the highest, so that the packaging can be quickly completed, and a processing space is not wasted. Advantages of the embodiment of determining packaging based on the first threshold are as follows: A quantity of transaction sub-requests in each sub-request group is fixed, which is convenient for the target relay node to package, and can also ensure that efficiency of the packaging is maximized.

FIG. 10 shows an example of a transaction request formed after packaging. A body of the transaction request includes a plurality of transaction sub-requests grouped into a same group.

Advantages of the embodiments of operations 410 to 430 are that the target relay node groups and packages the plurality of transaction sub-requests of the plurality of terminals, to form the transaction request to be sent to the blockchain node, so that the plurality of transaction sub-requests can be processed in batches, thereby improving the processing efficiency. In addition, after the transaction sub-requests are packaged into the transaction request, a uniform first signature can be performed by using a common first signature algorithm, without a need to switch signature algorithm, so that the first signature verification can be successfully performed subsequently, thereby smoothly providing a basis for a process of invoking the terminal contract to perform personalized second signature verification.

The foregoing describes the process of generating the transaction request in operation 310 in detail. A process of generating the first signature is described in the general descriptions of the blockchain transaction processing method in the embodiments of this disclosure, which may include a process of generating a digest of the transaction request by using the digest algorithm in the first signature algorithm, obtaining the public key of the blockchain node, and encrypting the digest by using the obtained public key. The following describes how to obtain the public key of the blockchain node.

A blockchain node public key is a concept opposite to a blockchain node private key. The blockchain node private key is a key secretly held by the blockchain node, and is known only by the blockchain node. The blockchain node public key is a key published by the blockchain node, and may be obtained by a node other than the blockchain node. The public key and the private key are a pair of keys used for encryption and decryption. When the private key is used for encryption, the public key is generally used for decryption. When the public key is used for encryption, the private key is generally used for decryption. In the embodiments of this disclosure, because the target relay node does not know the private key of the blockchain node, but can obtain the public key of the blockchain node, the digest may be encrypted by using the blockchain node public key, to obtain the first signature. After receiving the first signature, because the blockchain node knows the private key of the blockchain node, the blockchain node private key may be used for decryption, to perform signature verification.

The public and private keys of the blockchain nodes are generally generated by the blockchain node by requesting an authorization center (not shown), and the authorization center generates the public and private keys and then issues the public and private keys to the blockchain node. After receiving the generated public and private keys, the blockchain node holds the blockchain node private key and publishes the blockchain node public key.

A manner of publishing the blockchain node public key is that the blockchain node broadcasts the blockchain node public key to other nodes. In this embodiment, a manner in which the target relay node obtains the blockchain node public key may be as follows: After receiving the blockchain node public key broadcast by the blockchain node, the blockchain node public key is stored locally in correspondence with an identifier of the blockchain node; and when first signature needs to be performed on the transaction request, the blockchain node public key corresponding to the identifier of the blockchain node is locally retrieved based on the identifier of the blockchain node. An advantage of this embodiment is that the blockchain node public key can be directly and locally obtained without an external search, so that obtaining efficiency is high.

Another manner of publishing the blockchain node public key is publishing the blockchain node public key in a website of the blockchain network. When the first signature needs to be performed on the transaction request, the target relay node directly obtains the blockchain node public key from the website. An advantage of this embodiment is that an internal storage space of the target relay node is saved.

### Detailed Descriptions of Operation 320

In operation 320, the blockchain node performs, by using the first signature algorithm, first signature verification on the transaction request and the first signature received from the target relay node.

As described in the general descriptions of the blockchain transaction processing method in the embodiments of this disclosure, a signature verification process includes: decrypting the first signature by using the private key of the blockchain node, to obtain a decrypted digest; performing digest generation on the transaction request by using the digest algorithm in the first signature algorithm; and comparing the decrypted digest with a generated digest of the transaction request, where if the two digests are consistent, verification succeeds; otherwise, the verification fails.

When the target relay node performs first signature, digest generation is performed on the transaction request by using the digest algorithm in the first signature algorithm. When the blockchain node performs signature verification, the digest algorithm in the first signature algorithm is also used for digest generation performed on the transaction request. The two digest algorithms are consistent, ensuring correctness of the signature verification. The private key of the blockchain node is held by the blockchain node, and therefore can be obtained smoothly.

The function of the signature verification is verifying that the transaction request is actually generated by the target relay node, and verify that the transaction request is not lost during transmission. If a part of the transaction request is lost during transmission, a generated digest of the transaction request is not consistent with a digest after decryption, and signature verification cannot succeed. In addition, the signature verification is a precondition for triggering execution of the relay contract, so that the relay contract can be triggered for execution, to execute a process of invoking the terminal contract to perform personalized signature verification specified in the relay contract.

If the signature verification fails, a message indicating that the signature verification fails may be directly notified to the target relay node for re-transmission by the target relay node.

### Detailed Descriptions of Operation 330

After the first signature verification in operation 320 succeeds, in operation 330, the blockchain node needs to invoke (or execute) the relay contract of the target relay node. Different relay nodes have different relay contracts. An execution condition of the relay contract is: the first signature verification succeeds. The relay contract specifies that the transaction sub-requests in the transaction request from the target relay node are obtained, and for each transaction sub-request, the terminal contract corresponding to the transaction sub-request is invoked. The terminal contract specifies that the second signature verification is performed by using the second signature algorithm personalized to the terminal. Note that as described earlier, a contract may be invoked or executed to perform actions specified in the contract.

The relay contract is a smart contract made by the relay node and the blockchain network in advance, to execute any personalized processing that the relay node expects the blockchain network to execute. For example, in the embodiments of this disclosure, the corresponding terminal contract is invoked and executed for each transaction sub-request included in the transaction request. A process of making a relay contract is first described.

In an embodiment, the relay contract is mainly made by coding a relay contract rule expected by the target relay node by a contract making node. As shown in FIG. 13, the process of making a relay contract specifically includes: 1310: receiving a relay contract making request from the target relay node, where the relay contract making request includes a relay node identifier and a relay contract rule of the target relay node; 1320: sending the relay contract rule to the contract making node, and code the relay contract rule by the contract making node, to generate the relay contract; and 1330: receiving the relay contract from the contract making node, and storing the relay contract in correspondence with the relay node identifier of the target relay node.

The following describes operations 1310 to 1330 in detail.

A relay contract making process occurs before operation 310 in the embodiments of this disclosure. In operation 1310, the blockchain node receives the relay contract making request from the target relay node. The relay contract making request is a request configured for making a relay contract, and may include the relay node identifier and the relay contract rule of the target relay node. The relay node identifier is an identifier configured for indicating or identifying the relay node, for example, a relay node address or a relay node code. Identifiers of different relay nodes are different. The relay contract rule is a text description configured to describe a personalized operation that the target relay node needs the blockchain node to perform. The relay contract is a code representation of the personalized operation that the target relay node expects the blockchain node to perform. A difference between the relay contract rule and the relay contract lies in that the relay contract rule is a text description, and the relay contract is code corresponding to the relay contract rule. The contract making node functions to code the relay contract rule.

In operation 1320, a process of coding the relay contract rule by the contract making node may be automatically implemented, or may be implemented through programming by a programmer. In an embodiment of automatic implementation, a plurality of code segments corresponding to various keywords are preset, and the code segments include parameters that need to be filled. A keyword is recognized from the relay contract rule; a code segment corresponding to the keyword is obtained; and semantics of the relay contract rule is recognized by using a semantic recognition algorithm, a parameter in the code segment is determined based on the recognized semantics, and filled in the code segment. In the manner of automatic implementation, the relay contract may be automatically generated for the relay contract rule through artificial intelligence, thereby improving efficiency of generating the relay contract.

In operation 1330, the relay contract is stored in correspondence with the relay node identifier of the target relay node, so that after the first signature verification succeeds, the corresponding relay contract can be found through the relay node identifier when the relay contract needs to be executed in operation 330.

In an embodiment, a storage manner of the relay contract and the relay node identifier of the target relay node is local storage, and the relay contract and the relay node identifier are stored locally in pairs, and may be directly invoked based on the relay node identifier during use.

In another embodiment, the storage manner of the relay contract and the relay node identifier of the target relay node is: the relay contract is stored in the blockchain, and the relay node identifier and a block identifier are stored locally in pairs. In an embodiment, the process specifically includes: storing the relay contract in a first block, and recording the first block on the blockchain; obtaining a first block identifier; and add a correspondence between relay node identifiers and first block identifiers to a local first correspondence table.

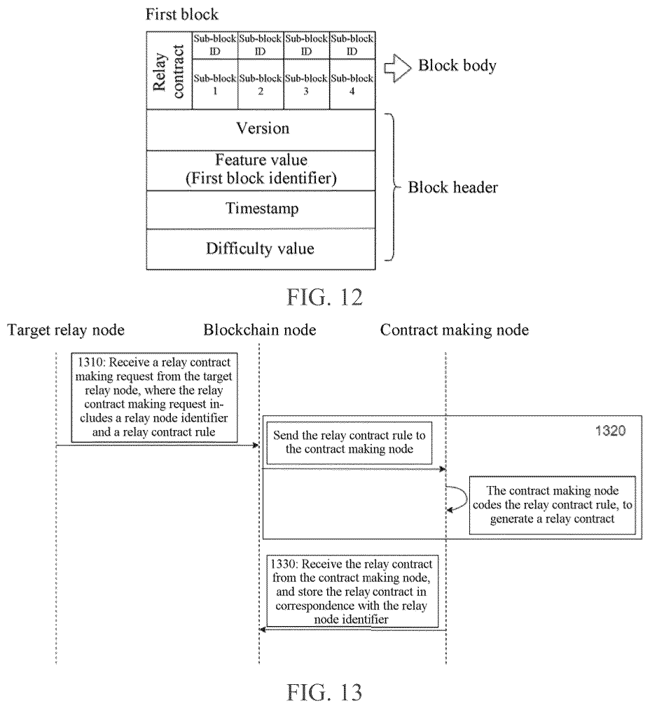

A structure of the first block after the relay contract is stored in the first block is shown in FIG. 12. The first block includes a block body and a block header. The block body is divided into a plurality of sub-blocks, and the relay contract may occupy only one of the sub-blocks, several of the sub-blocks, or all of the sub-blocks. FIG. 12 shows a situation in which the relay contract occupies all of the sub-blocks. In a case that only one or several of the sub-blocks are occupied, the remaining sub-blocks record another transaction that needs to be uploaded by another node to the blockchain. In other words, the blockchain node packages, into a block body, the sub-block occupied by the relay contract and a sub-block corresponding to a transaction that needs to be uploaded by another node to the blockchain, adds a block header to form a block, and records the block on the blockchain. The block header indicates related information of the block, including: a version, a feature value, a timestamp, a difficulty value, and the like. The first block identifier is an identifier that can distinguish the first block from other blocks, for example, a height of the first block or a feature value of the first block. The feature value of the first block is generally a digest value of a block body of the first block generated through the digest algorithm. Digest values are different due to different block bodies. Therefore, the digest values can uniquely distinguish between the blocks. The height of the first block means the sequential number of the first block on the blockchain. The height of the first block can also uniquely distinguish the first block from other blocks. The first correspondence table is stored locally and indicates a correspondence between the relay node identifiers and the first block identifiers.

Advantages of the manner of recording the relay contract through the blockchain are as follows: it is convenient for other nodes to check, the relay contract is unlikely to be tampered with, and security of the relay contract is improved.

Advantages of the embodiments of operations 1310 to 1330 are that the making and storage of the relay contract are completed through cooperation between the blockchain node, the contract making node, and the target relay node, thereby improving the generation efficiency of the relay contract, and the cooperation between a plurality of nodes improves security of the making process.

After the relay contract is made, in operation 330, the relay contract of the target relay node is invoked in response to that the first signature verification succeeds. As a smart contract, the relay contract may specify any personalized processing of the target relay node. In the embodiments of this disclosure, the relay contract specifies that after the first signature verification succeeds, the corresponding terminal contract is invoked for each transaction sub-request in the transaction request, to complete the personalized second signature verification.

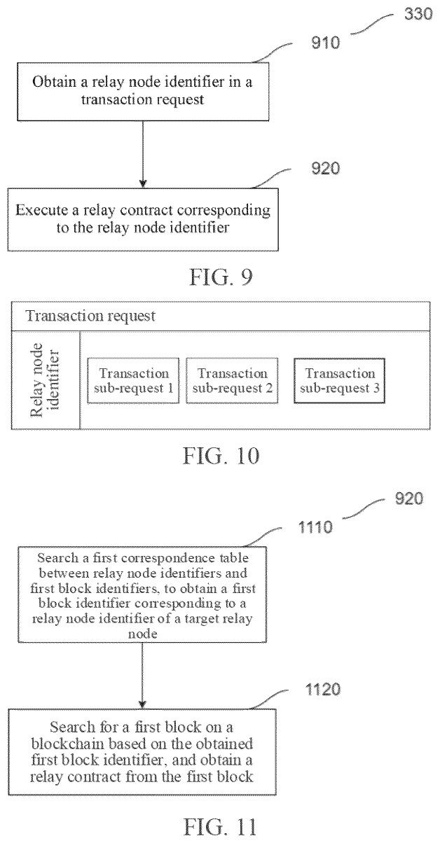

Because there may be a plurality of relay nodes, and different relay nodes correspond to different relay contracts, in an embodiment, executing the relay contract of the relay node, as shown in FIG. 9, includes: operation 910: obtaining the relay node identifier in the transaction request; and operation 920: invoking a relay contract corresponding to the relay node identifier.

The following describes operations 910 and 920 in detail.

The relay node identifier is an identifier that distinguishes the relay node from other relay nodes, which may be an address, a serial number, or the like of the relay node. In operation 910, an objective of obtaining the relay node identifier in the transaction request is that each relay node corresponds to a relay contract, and the corresponding relay contract can be found through the relay node identifier. The relay node identifier is shown in FIG. 10.

In the foregoing embodiment in which the relay node identifier and the relay contract are stored locally in the blockchain node in pairs, operation 920 may include: based on the relay node identifier, locally invoking the relay contract corresponding to the relay node identifier.

In the foregoing embodiment of uploading the relay contract to the blockchain and storing the relay contract, as shown in FIG. 11, operation 920 may include: operation 1110: searching the first correspondence table between relay node identifiers and first block identifiers, to obtain a first block identifier corresponding to the relay node identifier of the target relay node; and operation 1120: searching for the first block on the blockchain based on the obtained first block identifier, and obtaining the relay contract from the first block.

The first correspondence table is stored locally. In the first correspondence table, each relay node identifier corresponds to a first block identifier, and the first block identifier indicates the first block in which the relay contract of the relay node is stored in the blockchain. The first block can be found through the first block identifier, and the relay contract is taken out of the first block.

Advantages of the embodiments of operations 1110 and 1120 are as follows: Storing the relay contract by using the blockchain improves security, and occupies a small local storage space of the blockchain node.

In operation 330, after the relay contract is invoked, the relay contract invokes a corresponding terminal contract based on each transaction sub-request in the transaction request.

The terminal contract is a smart contract made by the terminal and the blockchain network in advance, to execute any personalized processing that the terminal expects the blockchain network to execute. For example, in the embodiments of this disclosure, the second signature verification is performed on the second signature by using the second signature algorithm personalized to the terminal. The following describes a process of making the terminal contract.

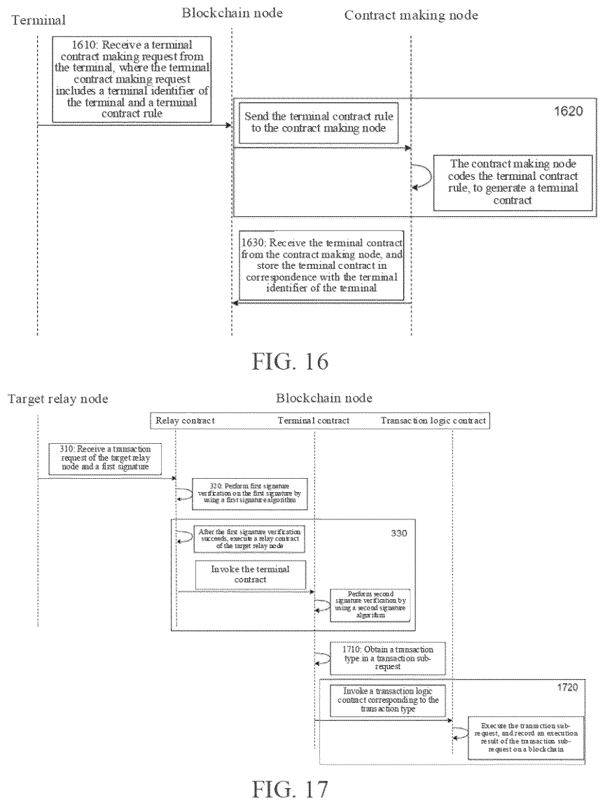

Similar to the foregoing process of making the relay contract, as shown in FIG. 16, in an embodiment, the process of making the terminal contract includes: operation 1610: receiving a terminal contract making request from the terminal, where the terminal contract making request includes the terminal identifier of the terminal and a terminal contract rule; operation 1620: sending the terminal contract rule to the contract making node, where the contract making node codes the terminal contract rule, to generate the terminal contract; and operation 1630: receiving the terminal contract from the contract making node, and storing the terminal contract in correspondence with the terminal identifier of the terminal.

The terminal contract making request is a request configured for making the terminal contract. The terminal identifier is configured for indicating an identifier of the terminal, for example, a terminal address or a terminal code. The terminal contract rule is a text description configured to describe a personalized operation that the terminal needs the blockchain node to perform. The terminal contract is a code representation of the personalized operation that the terminal needs the blockchain node to perform. In some example implementations, the code may include, for example, binary code. A difference between the terminal contract rule and the terminal contract lies in that the terminal contract rule is a text description, and the terminal contract is code corresponding to the terminal contract rule. Operation 1610 and 1620 are similar to corresponding operations in the foregoing relay contract formulation process, and reference may be made to the foregoing related descriptions. For operation 1630, the terminal contract may be stored locally or may be uploaded to the blockchain and stored.

In an embodiment, a manner of storing the terminal identifier and the terminal contract is local storage. The terminal identifier and the terminal contract are stored locally in pairs, and may be directly invoked based on the terminal identifier during use.

In another embodiment, the manner of storing the terminal identifier and the terminal contract is: storing the terminal contract on the blockchain, and locally storing the terminal identifier and the block identifier in pairs. In an embodiment, the process specifically includes: storing the terminal contract in a second block, and recording the second block on the blockchain; obtaining a second block identifier; and adding a correspondence between terminal identifiers and second block identifiers to a second correspondence table.

The second block is a block in which the terminal contract is stored. The second block identifier is an identifier distinguishing the second block from other blocks, and may include a second block feature value, a second block height, and the like. The second correspondence table is a table that records the correspondence between the terminal identifiers and the second block identifiers. A block structure after the terminal contract is stored in the second block is similar to the foregoing block structure after the relay contract is stored in the first block, as shown in FIG. 12. Therefore, details are not described herein again. Advantages of the manner of recording the terminal contract through the blockchain are as follows: it is convenient for other nodes to check, the terminal contract is unlikely to be tampered with, and security of the terminal contract is improved.

After the terminal contract is made, in an embodiment, the relay contract may invoke the corresponding terminal contract for each transaction sub-request, and perform signature verification on the second signature by using the second signature algorithm. As shown in FIG. 14, the process may specifically include: operation 1410: obtaining the terminal identifier in the transaction sub-request; and operation 1420: invoking the terminal contract corresponding to the terminal identifier, where the terminal contract performs the second signature verification by using the second signature algorithm.

In operation 1410, the terminal identifier may be directly obtained from the transaction sub-request, as shown in FIG. 5A to FIG. 5C. Based on the terminal identifier, the terminal contract needs to be invoked based on a correspondence between terminal identifiers and terminal contracts.

In the foregoing embodiment in which the terminal identifier and the terminal contract are directly stored locally in pairs, in operation 1420, the terminal contract corresponding to the terminal identifier may be found locally directly through the terminal identifier.

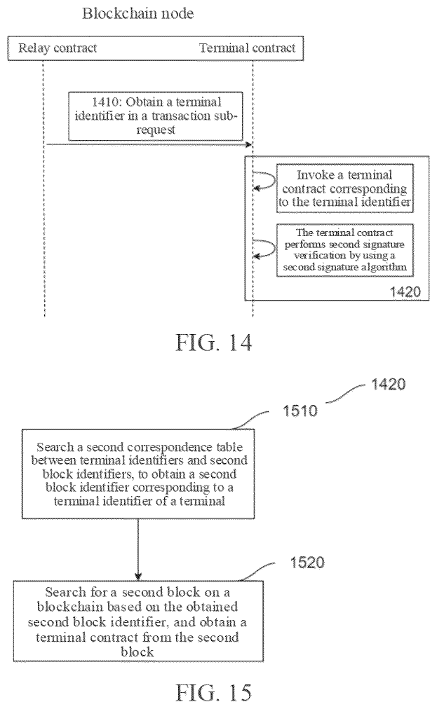

In the foregoing embodiment in which the terminal contract is stored on the blockchain, in operation 1420, the second block identifier may be found through the terminal identifier, and then the corresponding terminal contract is obtained based on the second block identifier. As shown in FIG. 15, in an embodiment, invoking the terminal contract by using the terminal identifier includes: operation 1510: searching a second correspondence table between terminal identifiers and second block identifiers, to obtain a second block identifier corresponding to the terminal identifier of the terminal; and operation 1520: searching for the second block on the blockchain based on the obtained second block identifier, and obtaining the terminal contract from the second block.

The second correspondence table is stored locally. In the second correspondence table, each of the terminal identifiers is stored corresponding to one of the second block identifiers. After the terminal identifier is obtained, the second block identifier corresponding to the terminal identifier may be found in the second correspondence table, and the terminal contract of the terminal indicated by the terminal identifier is stored in a block indicated by the second block identifier. Advantages of storing the terminal contract by using the blockchain and invoking the terminal contract through the block identifier are as follows: Storing the terminal contract by using the blockchain improves security, and occupies a small local storage space of the blockchain node.

An advantage of the embodiments of operations 1410 and 1420 is that the terminal contract is quickly invoked by using the terminal identifier, thereby improving efficiency of invoking the terminal contract.

The terminal contract specifies that second signature verification is performed on the transaction sub-request by using the second signature algorithm. The second signature algorithm is a personalized signature algorithm used by the terminal to perform second signature on the transaction sub-request. For example, the terminal performs second signature on the transaction sub-request by using the second signature algorithm A. In this case, second signature verification is performed on the second signature by using the same second signature algorithm A through the terminal contract.

After the second signature verification performed on the second signature by using the terminal contract succeeds, specific transaction request content in the transaction sub-request, namely, a transaction that needs to be processed on the blockchain node, is obtained. There are a large number of types of transactions, including: virtual resource transfer, information update, and the like. Different processing manners are used for different transaction types. The blockchain node in the embodiments of this disclosure processes different transaction types by using different transaction logic contracts.

When the blockchain network needs to process a transaction of a new transaction type, a transaction logic contract corresponding to the transaction type needs to be generated. In an embodiment, a specific generation manner includes: formulating a transaction logic contract rule based on the transaction type; sending the transaction logic contract rule to a contract making node, and coding the transaction logic contract rule by the contract making node, to generate the transaction logic contract; and receiving the transaction logic contract from the contract making node, and storing the transaction type in correspondence with the transaction logic contract.

A process of generating the transaction logic contract is similar to the processes of generating the relay contract and the terminal contract, and details are not described herein again.

In an embodiment, the transaction type and the transaction logic contract are stored through the blockchain, specifically including: storing the transaction logic contract in a third block, and recording the third block on the blockchain; obtaining a third block identifier; and storing a correspondence between transaction types and third block identifiers in a third correspondence table.

A structure of the third block is similar to the structure of the first block in the foregoing (FIG. 12), the transaction logic contract is stored in the block body, and the third block identifier may be a feature value in the block header, or the like.

The third correspondence table is stored locally in the blockchain node. In the third correspondence table, each of the transaction types corresponds to one of the third block identifiers.

An advantage of the transaction logic contract being uploaded to the blockchain and stored is that security of the transaction contract is improved.

A process of invoking the transaction logic contract to execute the transaction sub-request occurs after operations 310 to 330. As shown in FIG. 17, in an embodiment, the process may include: operation 1710: obtaining the transaction type in the transaction sub-request; and operation 1720: invoking the transaction logic contract corresponding to the transaction type, executing the transaction sub-request, and recording an execution result of the transaction sub-request on the blockchain.

The transaction type is recorded in the transaction sub-request sent by the terminal. As shown in FIG. 5A to FIG. 5C, a plurality of embodiments of transaction sub-requests include transaction types. An objective of recording the transaction type is quickly invoking the transaction logic contract through the transaction type, improving the transaction processing efficiency.

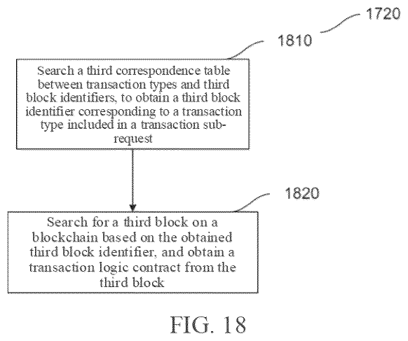

In a case that the transaction logic contract is uploaded to the blockchain and stored in the foregoing, in an embodiment, invoking the transaction logic contract based on the transaction type, as shown in FIG. 18, specifically includes: operation 1810: searching the third correspondence table between transaction types and third block identifiers, to obtain the third block identifier corresponding to the transaction type included in the transaction sub-request; and operation 1820: searching for the third block on the blockchain based on the obtained third block identifier, and obtaining the transaction logic contract from the third block.

The third correspondence table stores the correspondence between the transaction types and the third block identifiers, the third block identifier may be obtained based on the transaction type, and the third block indicated by the third block identifier stores the transaction logic contract corresponding to the transaction type. Advantages of storing the transaction logic contract by using the blockchain and invoking the transaction logic contract through the block identifier are similar to the foregoing advantages of storing the relay contract by using the blockchain. Details are not described herein again.

The transaction logic contract includes specific code for executing the transaction type, an execution result of the target transaction sub-request may be obtained by bringing a specific parameter of the target transaction sub-request into the transaction logic contract, and finally the execution result is uploaded to the blockchain.

In an embodiment, uploading the execution result to the blockchain includes: obtaining an execution result of the transaction sub-request; and recording the execution result on the blockchain.

In this embodiment, a transaction processing procedure can be completed by recording the execution result on the blockchain.

In another embodiment, uploading the execution result to the blockchain includes: obtaining an execution result of the transaction sub-request; and recording the execution result on the blockchain, and obtaining a corresponding block identifier.

In this embodiment, after the execution result is recorded on the blockchain, a corresponding block identifier needs to be obtained. An advantage is that it can be clearly known which block or blocks are changed. When data of transaction processing needs to be modified, the block in which the data is recorded may be directly found based on the block identifier. For example, after a virtual resource transfer transaction of an object is processed, the object wants to recall the transaction. After receiving a recall request, the blockchain node may directly obtain the block identifier of the block in which a result is recorded before, and modify the corresponding block, to improve the transaction processing efficiency.

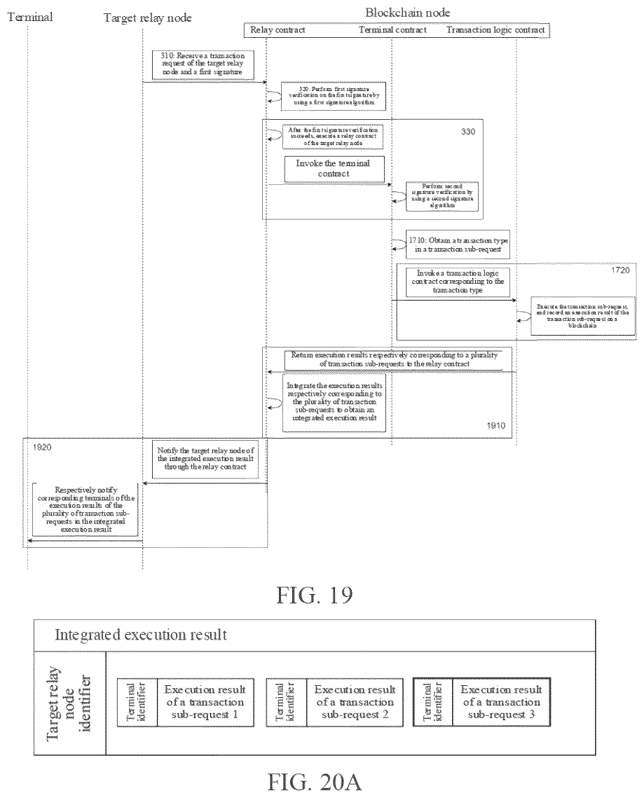

After the execution result is uploaded to the blockchain, the corresponding terminal needs to be notified of the execution result. An exemplary specific process is shown in FIG. 19, including: operation 1910: returning execution results respectively corresponding to the plurality of transaction sub-requests to the relay contract, where the relay contract integrates the execution results respectively corresponding to the plurality of transaction sub-requests to obtain an integrated execution result; and operation 1920: notifying the target relay node of the integrated execution result through the relay contract, where the target relay node respectively notifies corresponding terminals of the execution results of the plurality of transaction sub-requests in the integrated execution result.

The following describes operations 1910 and 1920 in detail.

Because the transaction request is traversed in the relay contract, and the corresponding terminal contract and the transaction logic contract are sequentially executed on the transaction sub-requests in the transaction request, execution results of the transaction sub-requests are sequentially received in the relay contract (but a sequence of receiving the execution results is not necessarily a sequence of taking out and executing the terminal contract and the transaction logic contract). A transaction execution result set exists in the relay contract, and is configured for temporarily storing data related to the transaction execution result, including data related to the execution result of the transaction sub-request. The transaction execution result set and the relay node identifier of the target relay node form the integrated execution result.

In an embodiment, that the relay contract integrates the execution results respectively corresponding to the plurality of transaction sub-requests includes: obtaining an execution result of each transaction sub-request in the transaction request, and storing the execution result and a corresponding terminal identifier in the transaction execution result set; obtaining the relay node identifier of the target relay node; and integrating the transaction execution result set and the relay node identifier of the target relay node to form the integrated execution result.

Each execution result corresponds to a terminal identifier, which is configured for indicating that the execution result needs to be notified to a corresponding terminal. An exemplary structure of the transaction execution result set is {terminal 1: execution result 1; terminal 2: execution result 2; terminal 3: execution result 3}.

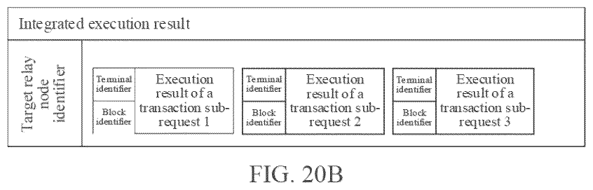

After all the transaction sub-requests in the transaction request obtain execution results and the execution results are stored in the transaction execution result set, the transaction execution result set and the relay node identifier of the target relay node form the integrated execution result. A structure of the integrated execution result is shown in FIG. 20A.

In the foregoing embodiment in which the execution result of the transaction sub-request is obtained, the execution result is recorded on the blockchain, and the corresponding block identifier is obtained, the relay contract integrates the execution results respectively corresponding to the plurality of transaction sub-requests to obtain the integrated execution result may include: obtaining the execution result of each transaction sub-request in the transaction request, and storing the execution result, the corresponding block identifier, and the corresponding terminal identifier in the transaction execution result set; obtaining the relay node identifier of the target relay node; and integrating the transaction execution result set and the relay node identifier of the target relay node to form the integrated execution result.

In addition to each execution result, the relay contract further receives the corresponding block identifier, and the block identifier indicates a block in which the execution result is stored. Therefore, in this embodiment, data stored in the transaction execution result set includes: the execution result, the block identifier, and the terminal identifier. An exemplary structure of the transaction execution result set is: {terminal 1: (execution result 1, block identifier 1); terminal 2: (execution result 2, block identifier 2); terminal 3: (execution result 3, block identifier 3)}. The integrated execution result in this embodiment is shown in FIG. 20B. The integrated execution result includes execution results of all transaction sub-requests packaged and sent by the target relay node, a terminal identifier of a terminal that needs to be notified, and the block identifier of the block in which the execution result is stored.

After receiving the integrated execution result, the relay contract needs to notify a corresponding terminal of the execution result of each transaction sub-request. Each transaction sub-request includes the terminal identifier, and the execution results are sequentially sent to the terminals based on the terminal identifiers.

An advantage of the embodiment is that the execution result of the transaction sub-request is returned along with the block identifier, which is convenient for the object to check whether the execution result is uploaded to the blockchain correctly, improving security of uploading the execution result to the blockchain.

In an embodiment, based on the structure of the integrated execution result in FIG. 20A, that the relay node notifies the terminal of the execution result of the transaction sub-request specifically includes: obtaining the execution result and the terminal identifier; and notifying the corresponding terminal of the execution result based on the terminal identifier.

When performing the foregoing process, the relay node may obtain the corresponding terminal identifier for each execution result, and notify the corresponding terminal of the execution result based on the terminal identifier, or may collect execution results of a same terminal identifier, and notify the terminal corresponding to the terminal identifier together. The processing manner in which the relay node collects the execution results of the same terminal identifier is conducive to improving notification efficiency.

In another embodiment, notifying the terminal of the execution result of the transaction sub-request based on the structure of the integrated execution result in FIG. 20B specifically includes: obtaining the execution result and the terminal identifier; and notifying the corresponding terminal of the execution result and the block identifier based on the terminal identifier.

A difference between this embodiment and the previous embodiment lies in that the corresponding terminal is notified of the block identifier at the same time, which is conducive to checking uploading of the execution result to the blockchain by the object, to improve security of uploading to the blockchain.

### Implementation Detail Diagram of the Blockchain Transaction Processing Method in the Embodiments of this Disclosure

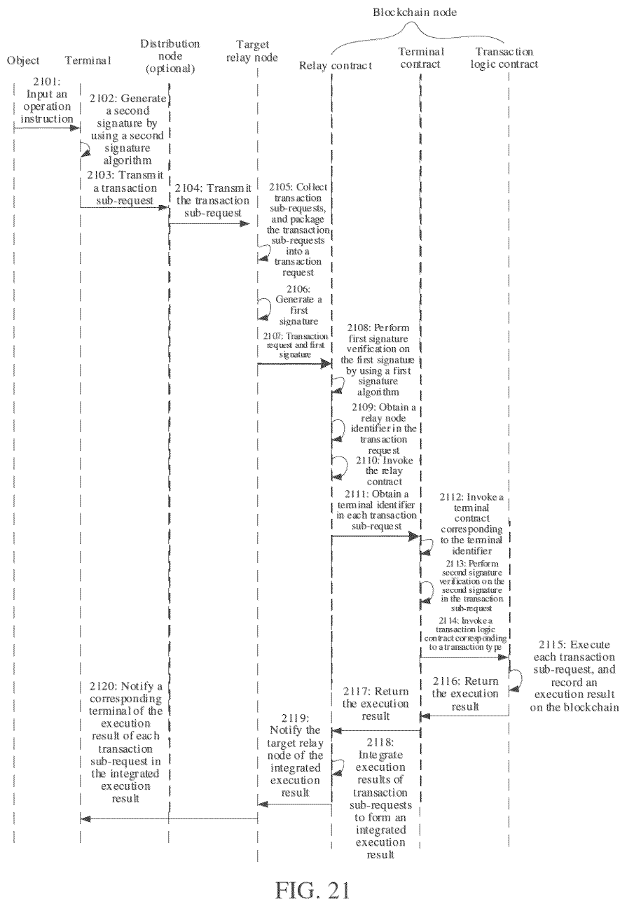

The following exemplarily describes implementation details of the blockchain transaction processing method in the embodiments of this disclosure in detail with reference to FIG. 21.

In operation 2101, an object A opens a blockchain processing application on a corresponding terminal, inputs an operation instruction indicating that resource transfer needs to be performed, and instructs to transfer 1000 virtual resources of the object A to an object B.

In operation 2102, the terminal generates a transaction sub-request based on the operation instruction of performing resource transfer of the object A, and generates a second signature by using a second signature algorithm personalized to the object A.

In operation 2103, the terminal sends the transaction sub-request with the second signature to a distribution node.

In operation 2104, the distribution node transmits the transaction sub-request to a target relay node.

In operation 2105, the target relay node collects the transaction sub-request sent by the terminal of the object A and another transaction sub-request sent by another terminal, and packages the transaction sub-requests into a transaction request.

In operation 2106, the target relay node signs the transaction request by using a first signature algorithm of a blockchain node, to obtain a first signature.

In operation 2107, the target relay node sends the transaction request and the first signature to the blockchain node.

In operation 2108, the blockchain node performs first signature verification on the first signature by using the first signature algorithm.

In operation 2109, after the first signature verification succeeds, the blockchain node obtains a relay node identifier in the transaction request.

In operation 2110, the blockchain node invokes, based on the relay node identifier, a relay contract corresponding to the relay node identifier.

In operation 2111, the relay contract obtains, for each transaction sub-request in the transaction request, a terminal identifier in each transaction sub-request.

In operation 2112, the relay contract invokes, based on the terminal identifier, a terminal contract corresponding to the terminal identifier.

In operation 2113, the terminal contract performs second signature verification on the second signature in the transaction sub-request by using the second signature algorithm of the blockchain node.

In operation 2114, after the second signature verification succeeds, the terminal contract invokes, based on a transaction type in the transaction sub-request, a transaction logic contract corresponding to the transaction type.

In operation 2115, the transaction logic contract executes each transaction sub-request, and records an execution result on the blockchain.

In operation 2116, the transaction logic contract returns the execution result to the terminal contract.

In operation 2117, the terminal contract returns the execution result to the relay contract.

In operation 2118, the relay contract integrates the execution results of the transaction sub-requests to form an integrated execution result.

In operation 2119, the relay contract notifies the target relay node of the integrated execution result.

In operation 2120, the target relay node notifies a corresponding terminal of the execution result of each transaction sub-request in the integrated execution result.

### Descriptions of an Apparatus and a Device in the Embodiments of this Disclosure

Although the steps are displayed sequentially according to the indications of the arrows in the flowcharts of the embodiments, these steps are not necessarily performed sequentially in the sequence indicated by the arrows. Unless otherwise explicitly specified in the embodiments, execution of the steps is not strictly limited, and the steps may be performed in other sequences. Moreover, at least some of the steps in the flowcharts may include a plurality of steps or a plurality of stages. The steps or stages are not necessarily performed at the same time but may be performed at different time. Execution of the steps or stages is not necessarily sequentially performed, but may be performed in turn or alternately with other steps or at least some of steps or stages of other steps.

When the foregoing embodiments of this disclosure are applied to a specific product or technology, user permission or consent needs to be obtained for processing relevant data such as user information, and collection, use, and processing of the relevant data need to comply with relevant laws, regulations, and standards of relevant countries and regions. In addition, when object registration information needs to be obtained in the embodiments of this disclosure, individual permission or individual consent of an object is obtained through a pop-up window or jumping to a confirmation page. After the individual permission or the individual consent of the object is explicitly obtained, necessary object-related data for enabling the embodiments of this disclosure to operate normally is obtained.

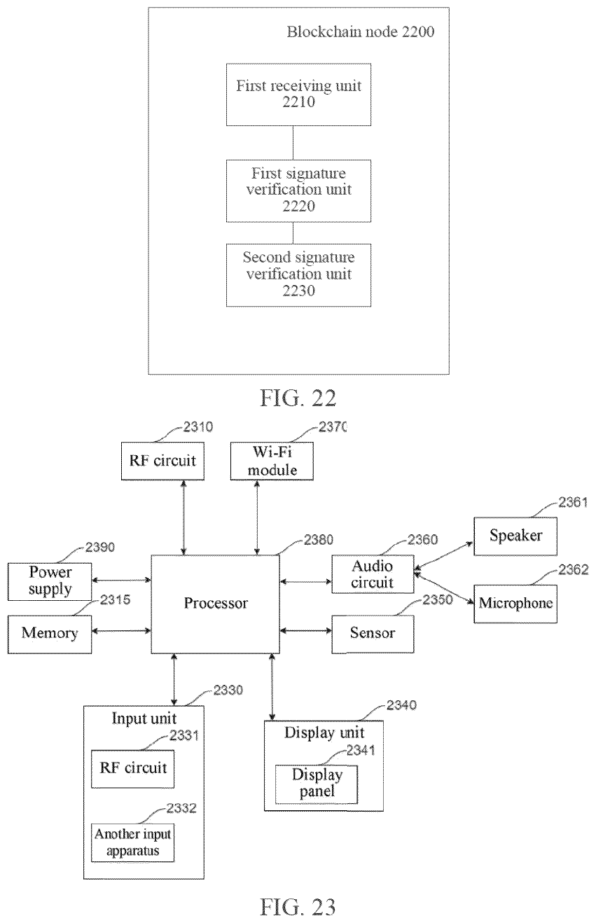

FIG. 22 is a schematic structural diagram of a blockchain node 2200 according to an embodiment of this application. The blockchain node 2200 includes: a first receiving unit 2210, configured to receive a transaction request from a target relay node and a first signature of the transaction request, the first signature being generated by signing the transaction request using a first signature algorithm of the blockchain node, the transaction request including a transaction sub-request received by the target relay node from a terminal, the transaction sub-request having a second signature, and the second signature being generated by using a second signature algorithm in a terminal contract of the terminal; a first signature verification unit 2220, configured to perform first signature verification on the first signature by using the first signature algorithm; and a second signature verification unit 2230, configured to: invoke a relay contract of the target relay node after determining that the first signature verification succeeds, obtain a transaction sub-request from the transaction request based on the relay contract, invoke the terminal contract of the terminal corresponding to the transaction sub-request, and perform second signature verification on the transaction sub-request by using the second signature algorithm in the terminal contract.

In some embodiments, the transaction request further includes a relay node identifier of the target relay node; and the second signature verification unit 2230 is specifically configured to: obtain the relay node identifier in the transaction request; and invoke the relay contract corresponding to the relay node identifier.

In some embodiments, the second signature verification unit 2230 is specifically configured to: search a first correspondence table between relay node identifiers and first block identifiers, to obtain a first block identifier corresponding to the relay node identifier of the target relay node; and search for a first block on a blockchain based on the obtained first block identifier, and obtain the relay contract from the first block.

In some embodiments, the blockchain node 2200 further includes: a second receiving unit (not shown), configured to receive a relay contract making request from the target relay node, the relay contract making request including the relay node identifier of the target relay node and a relay contract rule, and the relay contract rule being configured for invoking the terminal contract to perform the second signature verification on the transaction sub-request; a first sending unit (not shown), configured to send the relay contract rule to a contract making node, the contract making node being configured to code the relay contract rule, to generate the relay contract; and a third receiving unit (not shown), configured to receive the relay contract from the contract making node, and store the relay contract in correspondence with the relay node identifier of the target relay node.

In some embodiments, the transaction sub-request further includes a terminal identifier of the terminal; and the second signature verification unit 2230 is specifically configured to: obtain the terminal identifier in the transaction sub-request; and invoke the terminal contract corresponding to the terminal identifier, the terminal contract being configured for performing the second signature verification by using the second signature algorithm.

In some embodiments, the second signature verification unit 2230 is specifically configured to: search a second correspondence table between terminal identifiers and second block identifiers, to obtain a second block identifier corresponding to the terminal identifier of the terminal; and search for a second block on the blockchain based on the obtained second block identifier, and obtain the terminal contract from the second block.

In some embodiments, the blockchain node 2200 further includes: a fourth receiving unit, configured to receive a terminal contract making request from the terminal, the terminal contract making request including the terminal identifier of the terminal and a terminal contract rule, and the terminal contract rule including the second signature algorithm; a second sending unit, configured to send the terminal contract rule to the contract making node, the contract making node being configured to code the terminal contract rule, to generate the terminal contract; and a fifth receiving unit, configured to receive the terminal contract units from the contract making node, and store the terminal contract in correspondence with the terminal identifier of the terminal.

In some embodiments, the transaction request is generated by the target relay node in the following manner: receiving a plurality of transaction sub-requests from a plurality of terminals; grouping the plurality of transaction sub-requests; and packaging transaction sub-requests in a same sub-request group to generate the transaction request.

In some embodiments, the transaction sub-request includes a second signature algorithm type; and the grouping the plurality of transaction sub-requests includes: grouping the plurality of transaction sub-requests based on the second signature algorithm type.

In some embodiments, the packaging transaction sub-requests in the same sub-request group to generate the transaction request includes: determining a first quantity of transaction sub-requests grouped into a same sub-request group; and packaging transaction sub-requests in a sub-request group with the first quantity reaching a first threshold, to generate the transaction request.

In some embodiments, the receiving the plurality of transaction sub-requests from the plurality of terminals includes: receiving the plurality of transaction sub-requests of the plurality of terminals forwarded by a distribution node; and the target relay node is selected from a plurality of relay nodes by the distribution node in the following manner: obtaining a remaining storage space and a remaining processing capability of each relay node; and determining the target relay node from the plurality of relay nodes based on the remaining storage space and the remaining processing capability of each relay node.

In some embodiments, the receiving the plurality of transaction sub-requests from the plurality of terminals includes: receiving the plurality of transaction sub-requests of the plurality of terminals forwarded by a distribution node; and the target relay node is selected from a plurality of relay nodes by the distribution node in the following manner: obtaining a second signature algorithm type in the received transaction sub-request; obtaining a second quantity of unpackaged transaction sub-requests of the second signature algorithm type in each relay node; and selecting the target relay node from the plurality of relay nodes based on the second quantity.

In some embodiments, the transaction sub-request further includes a transaction type; and the blockchain node 2200 further includes: an obtaining unit, configured to obtain the transaction type in the transaction sub-request; and an invoking unit, configured to invoke a transaction logic contract corresponding to the transaction type, the transaction logic contract being configured for executing the transaction sub-request and recording an execution result of the transaction sub-request on the blockchain.

In some embodiments, the invoking unit is specifically configured to: search a third correspondence table between transaction types and third block identifiers, to obtain a third block identifier corresponding to the transaction type included in the transaction sub-request; and search for a third block on the blockchain based on the obtained third block identifier, and obtain the transaction logic contract from the third block.

In some embodiments, the transaction request includes a plurality of transaction sub-requests, and the blockchain node 2200 further includes: a returning unit, configured to return execution results respectively corresponding to the plurality of transaction sub-requests to the relay contract, the relay contract being configured for integrating the execution results respectively corresponding to the plurality of transaction sub-requests to obtain an integrated execution result; and a notification unit, configured to notify the target relay node of the integrated execution result through the relay contract, the target relay node being configured to notify corresponding terminals of the execution results respectively corresponding to the plurality of transaction sub-requests in the integrated execution result.

FIG. 23 is a structural block diagram of a part of a terminal that implements the blockchain transaction processing method in the embodiments of this disclosure. The terminal includes: components such as a radio frequency (RF) circuit 2310, a memory 2315, an input unit 2330, a display unit 2340, a sensor 2350, an audio circuit 2360, a wireless fidelity (Wi-Fi) module 2370, a processor 2380, and a power supply 2390. A person skilled in the art may understand that a structure of the terminal shown in FIG. 23 does not constitute a limitation to a mobile phone or a computer, and the mobile phone or the computer may include more components or fewer components than those shown in the figure, or some components may be combined, or a different component deployment may be used.

The RF circuit 2310 may be configured to receive and send a signal during receiving and sending information or a call. Specifically, the RF circuit 2310 receives downlink information from a base station and then provides the downlink information to the processor 2380 for processing; and sends uplink data to the base station.

The memory 2315 may be configured to store a software program and a module, and the processor 2380 runs the software program and the module stored in the memory 2315, to perform various functional applications and data processing of the terminal.

The input unit 2330 may be configured to receive inputted digit or character information, and generate a key signal input related to settings and function control of the terminal. Specifically, the input unit 2330 may include a touch panel 2331 and another input apparatus 2332.

The display unit 2340 may be configured to display inputted information or provided information and various menus of the terminal. The display unit 2340 may include a display panel 2341.

The audio circuit 2360, a speaker 2361, and a microphone 2362 may provide audio interfaces.

In this embodiment, the processor 2380 included in the terminal may perform the blockchain transaction processing method in the foregoing embodiments.

The terminal in the embodiments of this disclosure includes, but is not limited to, a mobile phone, a computer, a smart voice interaction device, a smart home appliance, an in-vehicle terminal, an aircraft, and the like. The embodiments of this disclosure may be applied to various scenarios, including, but not limited to, a blockchain, a digital signature, a smart contract, and the like.

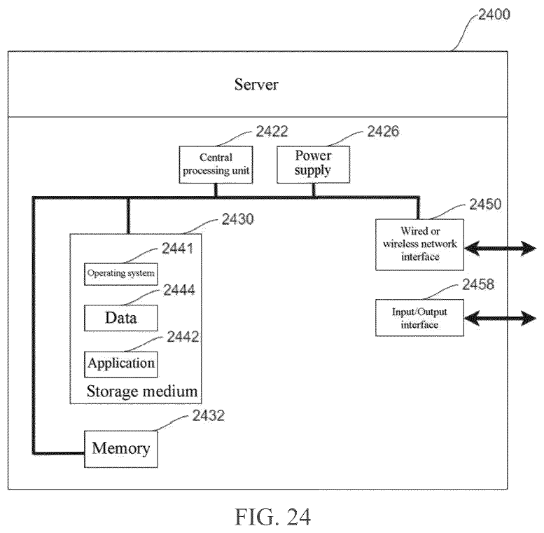

FIG. 24 is a structural block diagram of a part of a server 2400 that implements the blockchain transaction processing method in the embodiments of this disclosure. The server 2400 may vary greatly due to different configurations or performance, and may include one or more processors, for example, a central processing unit (CPU) 2422, and may include a memory 2432 and one or more storage media 2430 (for example, one or more mass storage devices, and/or one or more non-transitory storage media) for storing an application program 2442 or data 2444. The memory 2432 and the storage medium 2430 may be configured for transient storage or persistent storage. A program stored in the storage medium 2430 may include one or more modules (not marked in the figure), and each module may include a series of instruction operations on the server 2400. Further, the central processing unit 2422 may be configured to communicate with the storage medium 2430, and execute, on the server 2400, a series of instruction operations in the storage medium 2430.

The server 2400 may further include one or more power supplies 2426, one or more wired or wireless network interfaces 2450, one or more input/output interfaces 2458, and/or one or more operating systems 2441, for example, Windows Server™, Mac OS X™, Unix™, Linux™, FreeBSD™, and the like.

The central processing unit 2422 in the server 2400 may be configured to perform the blockchain transaction processing method in the embodiments of this disclosure.

An embodiment of this application further provides a non-transitory computer-readable storage medium. The non-transitory computer-readable storage medium is configured to store program code. The program code is configured for performing the blockchain transaction processing method according to the foregoing embodiments.

An embodiment of this application further provides a computer program product, and the computer program product includes a computer program. A processor of a computer device reads and executes the computer program, to cause the computer device to perform the blockchain transaction processing method.

The terms such as “first”, “second”, “third”, and “fourth” (if exist) in the specification of this application and in the accompanying drawings are used for distinguishing between similar objects and not necessarily used for describing any particular order or sequence. Data used in this way is exchangeable in a proper case, so that the embodiments of this disclosure described herein can be implemented in an order different from the order shown or described herein. In addition, the terms “include”, “comprise”, and any other variants are intended to cover the non-exclusive inclusion. For example, a process, method, system, product, or apparatus that includes a series of steps or units is not necessarily limited to those expressly listed steps or units, but may include other steps or units not expressly listed or inherent to such a process, method, product, or apparatus.

In this application, “at least one” means one or more, and “a plurality of” means two or more. “And/or” describes an association relationship between associated objects and represents that three relationships may exist. For example, A and/or B may represent the following three cases: Only A exists, both A and B exist, and only B exists, where A and B may be singular or plural. The character “/” generally indicates an “or” relationship between the associated objects. “At least one item (piece) of the following” or a similar expression means any combination of these items, including a single item (piece) or any combination of a plurality of items (pieces). For example, at least one item (piece) of a, b, or c may represent: a, b, c, “a and b”, “a and c”, “b and c”, or “a, b, and c”, where a, b, and c may be singular or plural.

In the descriptions of the embodiments of this disclosure, a plurality of (or multiple) means two or more, being greater than, being less than, and exceed a number, and the like are understood as excluding the number, and above, below, and within a number, and the like are understood as including the number.

In the several embodiments provided in this application, the disclosed system, apparatus, and method may be implemented in other manners. For example, the described apparatus embodiments are merely exemplary. For example, the unit division is merely logical function division and may be another division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and components displayed as units may or may not be physical units, that is, may be located in one position, or may be distributed on a plurality of network units. Some or all of the units may be selected based on actual needs to achieve the objectives of the solutions of the embodiments.

In addition, functional units in the embodiments of this disclosure may be integrated into one processing unit, or each of the units may be physically separated, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a non-transitory computer-readable storage medium. Based on such an understanding, the technical solutions of this application essentially, or the part contributing to the related art, or all or some of the technical solutions may be implemented in a form of a software product. The software product is stored in a storage medium, and includes several instructions for instructing a computer (which may be a personal computer, a server, a network apparatus, or the like) to perform all or some of the steps of methods described in the embodiments of this disclosure. The foregoing storage medium includes: various media capable of storing program code, such as a USB flash drive, a mobile hard disk, a read-only memory (ROM), a random access memory (RAM), a magnetic disk, a storage that is non-transitory, or an optical disc.

Various implementations provided in the embodiments of this disclosure may be combined in different manners to form other embodiments, to achieve different technical effects.

The foregoing describes the implementations of this application in detail, but this application is not limited to the foregoing implementations. A person skilled in the art may further make various equivalent modifications or replacements without departing from the spirit of this application, and these equivalent modifications or replacements are all included within the scope defined by the claims of this application.

What is claimed is:

1. A method for blockchain transaction processing, applied to a blockchain node in a blockchain and comprising:
receiving, from a target relay node, a transaction request and a first signature of the transaction request, the first signature being generated by signing the transaction request using a first signature algorithm of the blockchain node, the transaction request comprising a transaction sub-request received by the target relay node from a terminal, the transaction sub-request having a second signature, and the second signature being generated by using a second signature algorithm in a terminal contract of the terminal;
performing first signature verification on the first signature by using the first signature algorithm;
invoking a relay contract of the target relay node after determining that the first signature verification succeeds, to obtain a transaction sub-request from the transaction request based on the relay contract; and
invoking the terminal contract of the terminal corresponding to the transaction sub-request, to perform second signature verification on the transaction sub-request by using the second signature algorithm in the terminal contract.

2. The method according to claim 1, wherein:
the transaction request further comprises a relay node identifier of the target relay node; and
invoking the relay contract of the target relay node comprises:
obtaining the relay node identifier from the transaction request; and
invoking the relay contract corresponding to the relay node identifier.

3. The method according to claim 2, wherein invoking the relay contract corresponding to the relay node identifier comprises:
searching a first correspondence table between relay node identifiers and first block identifiers, to obtain a first block identifier corresponding to the relay node identifier of the target relay node; and
searching for a first block on the blockchain based on the obtained first block identifier, and obtaining the relay contract from the first block.

4. The method according to claim 2, wherein before receiving the transaction request and the first signature of the transaction request, the method further comprises:
receiving a relay contract making request from the target relay node, the relay contract making request comprising the relay node identifier of the target relay node and a relay contract rule, and the relay contract rule requiring invoking the terminal contract to perform the second signature verification on the transaction sub-request;
transmitting the relay contract rule to a contract making node, the contract making node being used to code the relay contract rule, to generate the relay contract; and
receiving the relay contract from the contract making node, and storing the relay contract in correspondence with the relay node identifier of the target relay node.

5. The method according to claim 1, wherein:
the transaction sub-request further comprises a terminal identifier of the terminal; and
invoking the terminal contract of the terminal corresponding to the transaction sub-request, to perform the second signature verification on the transaction sub-request comprises:
obtaining the terminal identifier in the transaction sub-request; and
invoking the terminal contract corresponding to the terminal identifier, to perform the second signature verification by using the second signature algorithm.

6. The method according to claim 5, wherein invoking the terminal contract corresponding to the terminal identifier comprises:
searching a second correspondence table between terminal identifiers and second block identifiers, to obtain a second block identifier corresponding to the terminal identifier of the terminal; and
searching for a second block on the blockchain based on the obtained second block identifier, and obtaining the terminal contract from the second block.

7. The method according to claim 5, wherein before receiving the transaction request and the first signature, the method further comprises:
receiving a terminal contract making request from the terminal, the terminal contract making request comprising the terminal identifier of the terminal and a terminal contract rule, and the terminal contract rule comprising the second signature algorithm;
transmitting the terminal contract rule to a contract making node, the contract making node being used to code the terminal contract rule, to generate the terminal contract; and
receiving the terminal contract from the contract making node, and storing the terminal contract in correspondence with the terminal identifier of the terminal.

8. The method according to claim 1, wherein the transaction request is generated by the target relay node in the following manner:
receiving a plurality of transaction sub-requests from a plurality of terminals;
grouping the plurality of transaction sub-requests; and
packaging transaction sub-requests in a same sub-request group to generate the transaction request.

9. The method according to claim 8, wherein:
each of the plurality of transaction sub-requests comprises a respective second signature algorithm type; and
grouping the plurality of transaction sub-requests comprises: grouping the plurality of transaction sub-requests based on the respective second signature algorithm type.

10. The method according to claim 8, wherein packaging the transaction sub-requests in the same sub-request group to generate the transaction request comprises:
determining a first quantity of the transaction sub-requests grouped into a same sub-request group; and
when the first quantity reaches a first threshold, packaging the transaction sub-requests into the same, to generate the transaction request.

11. The method according to claim 8, wherein:
receiving the plurality of transaction sub-requests from the plurality of terminals comprises: receiving the plurality of transaction sub-requests which are initiated from the plurality of terminals and are forwarded by a distribution node; and
the target relay node is selected from a plurality of relay nodes by the distribution node in a following manner:
obtaining a remaining storage space and a remaining processing capability of each relay node; and
determining the target relay node from the plurality of relay nodes based on the remaining storage space and the remaining processing capability of each relay node.

12. The method according to claim 8, wherein receiving the plurality of transaction sub-requests from the plurality of terminals comprises: receiving the plurality of transaction sub-requests of the plurality of terminals forwarded by a distribution node; and
the target relay node is selected from a plurality of relay nodes by the distribution node in a following manner:
obtaining a second signature algorithm type in the received transaction sub-request;
obtaining a second quantity of unpackaged transaction sub-requests of the second signature algorithm type in each relay node; and
selecting the target relay node from the plurality of relay nodes based on the second quantity.

13. The method according to claim 1, further comprising:
obtaining a transaction type in the transaction sub-request; and
invoking a transaction logic contract corresponding to the transaction type, the transaction logic contract being used for executing the transaction sub-request and recording an execution result of the transaction sub-request on the blockchain.

14. The method according to claim 13, wherein invoking the transaction logic contract corresponding to the transaction type comprises:
searching a third correspondence table between transaction types and third block identifiers, to obtain a third block identifier corresponding to the transaction type comprised in the transaction sub-request; and
searching for a third block on the blockchain based on the obtained third block identifier, and obtaining the transaction logic contract from the third block.

15. The method according to claim 13, wherein the transaction request comprises a plurality of transaction sub-requests, and wherein after invoking the transaction logic contract corresponding to the transaction type, the method further comprises:
returning execution results respectively corresponding to the plurality of transaction sub-requests to the relay contract, the relay contract being used for integrating the execution results respectively corresponding to the plurality of transaction sub-requests to obtain an integrated execution result; and
notifying the target relay node of the integrated execution result through the relay contract, the target relay node being used to notify corresponding terminals of the execution results respectively corresponding to the plurality of transaction sub-requests in the integrated execution result.

16. A blockchain node in a blockchain, the blockchain node comprising a memory for storing computer instructions and a processor in communication with the memory, wherein, when the processor executes the computer instructions, the processor is configured to cause the blockchain node to:
receive, from a target relay node, a transaction request and a first signature of the transaction request, the first signature being generated by signing the transaction request using a first signature algorithm of the blockchain node, the transaction request comprising a transaction sub-request received by the target relay node from a terminal, the transaction sub-request having a second signature, and the second signature being generated by using a second signature algorithm in a terminal contract of the terminal;
perform first signature verification on the first signature by using the first signature algorithm;
invoke a relay contract of the target relay node after determining that the first signature verification succeeds, to obtain a transaction sub-request from the transaction request based on the relay contract; and
invoke the terminal contract of the terminal corresponding to the transaction sub-request, to perform second signature verification on the transaction sub-request by using the second signature algorithm in the terminal contract.

17. The blockchain node according to claim 16, wherein:
the transaction request further comprises a relay node identifier of the target relay node; and
wherein, when the processor is configured to cause the blockchain node to invoke the relay contract of the target relay node, the processor is configured to cause the blockchain node to:
obtain the relay node identifier from the transaction request; and
invoke the relay contract corresponding to the relay node identifier.

18. The blockchain node according to claim 17, wherein, when the processor is configured to cause the blockchain node to invoke the relay contract corresponding to the relay node identifier, the processor is configured to cause the blockchain node to:
searching a first correspondence table between relay node identifiers and first block identifiers, to obtain a first block identifier corresponding to the relay node identifier of the target relay node; and
search for a first block on the blockchain based on the obtained first block identifier, and obtaining the relay contract from the first block.

19. The blockchain node according to claim 17, wherein, before the processor is configured to cause the device to receive the transaction request and the first signature of the transaction request, the processor is configured to further cause the blockchain node to:
receive a relay contract making request from the target relay node, the relay contract making request comprising the relay node identifier of the target relay node and a relay contract rule, and the relay contract rule requiring invoking the terminal contract to perform the second signature verification on the transaction sub-request;
transmit the relay contract rule to a contract making node, the contract making node being used to code the relay contract rule, to generate the relay contract; and
receive the relay contract from the contract making node, and store the relay contract in correspondence with the relay node identifier of the target relay node.

20. A non-transitory storage medium for storing computer readable instructions, the computer readable instructions, when executed by a processor in a blockchain node in a blockchain, causing the processor to:
receive, from a target relay node, a transaction request and a first signature of the transaction request, the first signature being generated by signing the transaction request using a first signature algorithm of the blockchain node, the transaction request comprising a transaction sub-request received by the target relay node from a terminal, the transaction sub-request having a second signature, and the second signature being generated by using a second signature algorithm in a terminal contract of the terminal;
perform first signature verification on the first signature by using the first signature algorithm;
invoke a relay contract of the target relay node after determining that the first signature verification succeeds, to obtain a transaction sub-request from the transaction request based on the relay contract; and
invoke the terminal contract of the terminal corresponding to the transaction sub-request, to perform second signature verification on the transaction sub-request by using the second signature algorithm in the terminal contract.
